(19) United States
(12) Patent Application Publication
(10) Pub. No.: US 2021/0238318 A1
(43) Pub. Date: Aug. 5, 2021

(54) COMPOSITE FUNCTIONAL RESIN, PREPARATION METHOD THEREFOR AND USE THEREOF

(71) Applicants: Nanjing University, Nanjing (CN); NANJING UNIVERSITY & YANCHENG ACADEMY OF ENVIRONMENTAL PROTECTION TECHNOLOGY AND ENGINEERING, Yancheng (CN)

(72) Inventors: Peng SHI, Nanjing (CN); Huaicheng ZHANG, Nanjing (CN); Aimin LI, Nanjing (CN); Fangyu CHANG, Nanjing (CN); Qing ZHOU, Nanjing (CN); Chendong SHUANG, Nanjing (CN); Qimeng LI, Nanjing (CN); Yang PAN, Nanjing (CN)

(21) Appl. No.: 17/050,659

(22) PCT Filed: Oct. 24, 2018
(86) PCT No.: PCT/CN2018/111597

§ 371 Date: Oct. 26, 2020

(30) Foreign Application Priority Data
Apr. 27, 2018 (CN) 201810392644.8

(51) Int. Cl. C08F 8/44; C08F 220/32; C08F 226/06; C08F 224/00; A01N 33/12; C02F 1/50; C02F 1/42

(52) U.S. Cl. CPC C08F 8/44; C08F 220/325; C08F 226/06; C08F 224/00; C02F 2001/425; C02F 1/50; C02F 1/42; C02F 2303/04; A01N 33/12

(57) ABSTRACT

Disclosed is a composite functional resin, having the basic structure of Formula (I) and/or Formula (II), wherein A_{X} is a quaternary ammonium group. In view of the problems that the existing resins have poor anti-interference ability, and poor ability to remove dissolved organic matter, disinfection by-product precursors, and anions such as nitrate, sulfate, phosphate and arsenate in water while sterilizing, the composite functional resin of the present invention has the ability to efficiently remove dissolved organic matter, disinfection by-product precursors, and anions such as nitrate, sulfate, phosphate, and arsenate in water, and has the advantages of efficient sterilization and high anti-interference ability. The composite functional resin can be applied in sterilization and water treatment.

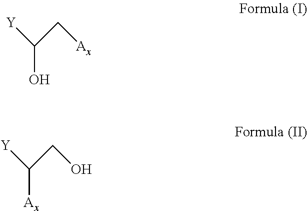

### BACKGROUND

### Technical Field

The present invention belongs to the field of resins, and specifically relates to a composite functional resin and a preparation method and application thereof.

### Related Art

A disinfection process is the main way to kill pathogenic microorganisms and ensure the safety of drinking water, mainly including chemical methods such as chlorine, chloramine, sodium hypochlorite, chlorine dioxide, ozone, and compound disinfection, and physical methods such as ultraviolet radiation. However, chemical disinfectants will react with natural organic matter in the water, synthetic organic pollutants, bromide, iodide, and the like in the disinfection process to produce a variety of disinfection by-products, such as trihalomethane, haloacetic acid, haloacetonitrile and nitrosamines. Many disinfection by-products are genetically toxic and carcinogenic, which seriously threaten the safety of drinking water.

Ultraviolet (UV) disinfection can also cause bacteria to be in a viable but non-cultivable state (S. Zhang et al. UV disinfection induces a VBNC state in Escherichia coli and Pseudomonas aeruginosa. Environ. Sci. Technol., 2015, 49: 1721-1728), and bacteria can be revived during subsequent pipeline transportation. In addition, there are a variety of chlorine and UV resistant pathogenic bacteria in drinking water, such as P. aeruginosa and Bacillus subtilis (T. Chiao et al. Differential resistance of drinking water bacterial populations to monochloramine disinfection, Environ. Sci. Technol. 2014, 48: 4038-4047; P. Roy et al. Chlorine resistant bacteria isolated from drinking water treatment plants in West Bengal. Desalin. Water Treat., 2017, 79: 103-107). Such bacteria are difficult to be inactivated by conventional disinfection methods and pose a greater health risk.

In order to solve the problems of disinfection by-products and residual toxicity of small-molecule bactericides and soluble polymer bactericides, water-insoluble immobilized bactericidal materials are prepared by polymerizing bactericide monomer compounds or immobilizing bactericidal functional groups on resin materials. The advantages of the immobilized bactericidal materials are that: 1) the bactericidal efficiency of the materials is high, because the bactericidal groups are concentrated on the surface of a carrier to form a high-concentration bactericide region; 2) the bactericidal materials will not cause secondary pollution to the water body, and solid-liquid separation is easy to realize; 3) the bactericidal materials are neither soluble in water nor soluble in organic solvents, avoiding the problems of toxicity, irritation and poor safety in use, and which can be applied to the treatment of drinking water; 4) the bactericidal materials are renewable and reusable; and 5) the diversity of the carrier makes their application range very wide. Resin material is an important component of many polymer disinfectants. Traditional antibacterial resins are mainly divided into additive antibacterial resins and structural antibacterial resins. The additive antibacterial resins include the resins described in Chinese Patent Applications No. CN1280771A, CN102933648A, and CN101891865A, in which a disinfectant is impregnated and immobilized in resins, but there are still problems such as easy migration and loss of the disinfectant and short service life.

The disinfectants with the quaternary ammonium salt structure have the advantages of safety and efficiency. In recent years, there are more and more reports on materials modified with quaternary ammonium salt groups for sterilization.

When used for sterilization, the current resins have the following problems:

(1) while sterilizing, it is easy to be interfered by organics, heavy metal ions, some anionic surfactants or some macromolecular anionic compounds in the water, especially by high-concentration of chloride ions, which will greatly reduce the ability of sterilization;

(2) while sterilizing, the current resins have poor ability to remove dissolved organics, precursors of disinfection by-products, and anions such as nitrate, sulfate, phosphate, and arsenate in water.

In summary, the existing resins have poor anti-interference ability, and poor ability to remove dissolved organics, disinfection by-product precursors, and anions such as nitrate, sulfate, phosphate and arsenate in water while sterilizing.

### SUMMARY

### 1. Technical Problems to be Solved

In view of the problems that the existing resins have poor anti-interference ability, and poor ability to remove dissolved organics, disinfection by-product precursors, and anions such as nitrate, sulfate, phosphate and arsenate in water while sterilizing, the present invention provides a composite functional resin. The composite functional resin of the present invention has the ability to efficiently remove dissolved organics, disinfection by-product precursors, and anions such as nitrate, sulfate, phosphate, and arsenate in water, and has the advantages of efficient sterilization and high anti-interference ability. The present invention also provides a method for preparing the composite functional resin, and an application of the composite functional resin in sterilization and in water treatment.

### 2. Technical Solution

In order to solve the above problems, the technical solutions of the present invention are as follows:

The present invention provides a composite functional resin, and the composite functional resin has the basic structure of the following Formula (I) and/or Formula (II),

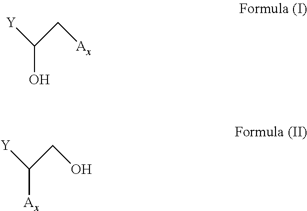

wherein A_{X} is a quaternary ammonium group:

Y has the structure of any one or more of Formula (101), Formula (102), Formula (103) and Formula (104),

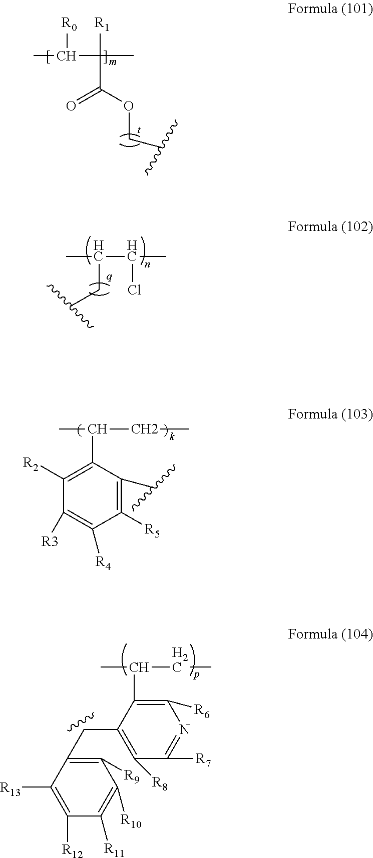

wherein R₀, R₁, R₂, R₃, R₄, R₅, R₆, R₇, R₈, R₉, R₁₀, R₁₁, R₁₂ and R₁₃ are H or hydrocarbyl groups; m, n, k and p are the number of repeating units, ranging from 500 to 3,000;

the number of carbon atoms of t and q is in a range of 1-30, more preferably 1-20, and still more preferably 1-10;

the number of carbon atoms of R₀, R₁, R₂, R₃, R₄, R₅, R₆, R₇, R₈, R₉, R₁₀, R₁₁, R₁₂ and R₁₃ is in a range of 0-30;

and wherein “ [symbol] ” in the structural formula represents the site where the structure is connected to that of Formula (I) or Formula (I); and

m, n, k and p are preferably 500-2,500, more preferably 500-2,300, still more preferably 800-2,300, and most preferably 800-2,000.

When R₀, R₁, R₂, R₃, R₄, R₅, R₆, R₇, R₈, R₉, R₁₀, R₁₁, R₁₂ and R₁₃ are hydrocarbyl groups, the number of carbon atoms is preferably 1-30, more preferably 1-20, still more preferably 5-20, and most preferably 5-15.

Preferably, the crosslinking degree of the composite functional resin is 1-35%, the particle size of the composite functional resin is 10-2,000 μm, and the surface N content of the composite functional resin accounts for 0.005-50.0% of the total N content of the composite functional resin.

The crosslinking degree is preferably 1-30%, more preferably 5-30%, still more preferably 5-25%, and most preferably 5-20%.

The surface N content of the composite functional resin accounts for preferably 0.005-40.0%, more preferably 1-30.0%, still more preferably 5.0-25.0%, and most preferably 10.0-25.0% of the total N content of the composite functional resin.

Preferably, the crosslinking degree of the composite functional resin is 10-25%, the particle size of the composite functional resin is 20-600 pin, the strong base exchange capacity of the composite functional resin is 0.3-4.0 mmol/g, and the resin surface charge density of the composite functional resin is 10¹-10²⁴ N⁺/g.

When the composite functional resin has a particle size of 20-600 μm, it has high bactericidal activity, moderate fluid resistance, and good settleability.

The particle size is preferably 20-400 μm, more preferably 20-300 μm, still more preferably 50-300 m, and most preferably 150-300 μm.

The strong base exchange capacity is preferably 1.5-3.0 mmol/g, more preferably 1.5-2.8 mmol/g, and most preferably 1.5-2.5 mmol/g.

The resin surface charge density of the composite functional resin is preferably 10¹⁶-10²⁴ N⁺/g, more preferably 10¹⁷-10²⁴ N⁺/g, still more preferably 10¹⁸-10²⁴ N⁺/g, and most preferably 10¹⁸-10²³N⁺/g.

Preferably, A_{X} has the structure of any one or more of Formula (201), Formula (202), Formula (203), Formula (204), Formula (205), Formula (206), Formula (207), Formula (208), Formula (209) and Formula (210),

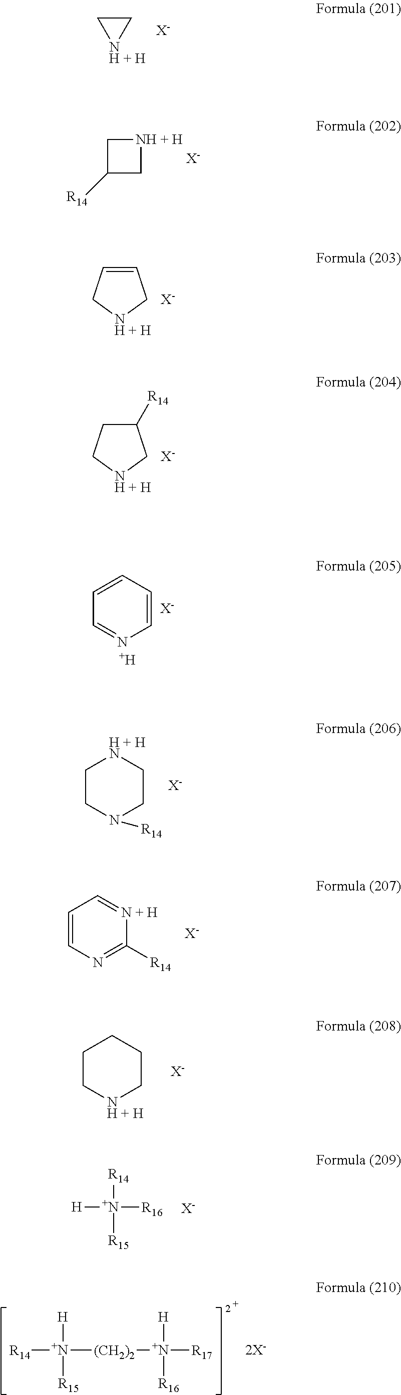

wherein, X is any one of Cl⁻, Br⁻, I⁻, I3⁻, I5⁻, I7⁻, OH⁻, SO₄²⁻, HCO₃⁻, and CO₃²⁻; R₁₄, R₁₅, R₁₆ and R₁₇ are respectively one of H or a hydrocarbyl group;

the number of carbon atoms of R₁₄, R₁₅, R₁₆ and R₁₇ is in a range of 0-40; and

when A_{X} has the structure of Formula (209) or Formula (210), the number of carbon atoms in the backbone is preferably 1-30, still more preferably 1-25, and most preferably 1-20.

The present invention also provides a preparation method of a composite functional resin, including: mixing a first resin containing an epoxy group and a first amine salt for a first quaternization reaction, wherein by controlling the reaction conditions and the type of the first amine salt, the first quaternization reaction occurs on the outer surface of the first resin; and then adding a second amine salt to the first quaternized resin for a second quaternization reaction, wherein by controlling the reaction conditions and the type of the second amine salt, the second quaternization reaction occurs on the inner surface of the first resin, to obtain the composite functional resin of the present invention. The outer surface and inner surface of the composite functional resin are combined with different types of quaternary ammonium groups. The quaternization reaction outside the resin improves the bactericidal ability of the resin, and the quaternization reaction inside the resin improves the anti-interference ability of the resin. Therefore, the composite functional resin has efficient bactericidal ability, the ability to resist the interference of anions and natural organic matter in the water, and the ability to efficiently remove dissolved organic matter, disinfection by-product precursors, and anions such as nitrate, sulfate, phosphate, and arsenate in water. The present invention also provides a preparation method of a composite functional resin, including the following steps:

(1) mixing a first resin, a first amine salt and a solvent C, and stirring the mixture for a first quaternization reaction to obtain the first quaternized resin; and

(2) mixing the first quaternized resin in step (1), a second amine salt, and a solvent D, and stirring the mixture for a second quaternization reaction to obtain the composite functional resin.

Preferably, the weight ratio of the first resin to the first amine salt in step (1) is 1:(0.5-10).

The weight ratio of the first resin to the first amine salt is preferably 1:(0.5-10), more preferably 1:(0.5-8), still more preferably 1:(0.5-6), and most preferably 1:(1-6).

Preferably, the reaction conditions in step (1) are: the reaction time is 12-72 h, the stirring speed is 200-800 rpm, and the reaction temperature is 50-150° C.

The reaction time in step (1) is preferably 12-60 h, more preferably 20-60 h, still more preferably 20-50 h, and most preferably 20-40 h.

The stirring speed in step (1) is preferably 200-700 rpm, more preferably 200-650 rpm, still more preferably 200-600 rpm, and most preferably 250-500 rpm.

The temperature in step (1) is preferably 50-140° C., more preferably 50-130° C., still more preferably 60-130° C., and most preferably 60-120° C.

Preferably, the weight ratio of the first quaternized resin to the second amine salt in step (2) is 1:(0.5-10).

The weight ratio of the first quaternized resin to the second amine salt is preferably 1:(0.5-10), more preferably 1:(0.5-8), still more preferably 1:(0.5-6), and most preferably 1:(1-5).

Preferably, the reaction conditions in step (2) are: the reaction time is 12-72 h, the stirring speed is 200-800 rpm, and the reaction temperature is 50-150° C.

The reaction time in step (2) is preferably 12-60 h, more preferably 20-60 h, still more preferably 20-50 h, and most preferably 20-40 h.

The stirring speed in step (2) is preferably 200-700 rpm, more preferably 200-650 rpm, still more preferably 200-600 rpm, and most preferably 250-500 rpm.

The temperature in step (2) is preferably 50-140° C., more preferably 50-130° C., still more preferably 60-130° C., and most preferably 60-120° C.

Preferably, the first amine salt has the structure of one or more of Formula (201), Formula (202), Formula (203), Formula (204), Formula (205), Formula (206), Formula (207), Formula (208), Formula (209) and Formula (210),

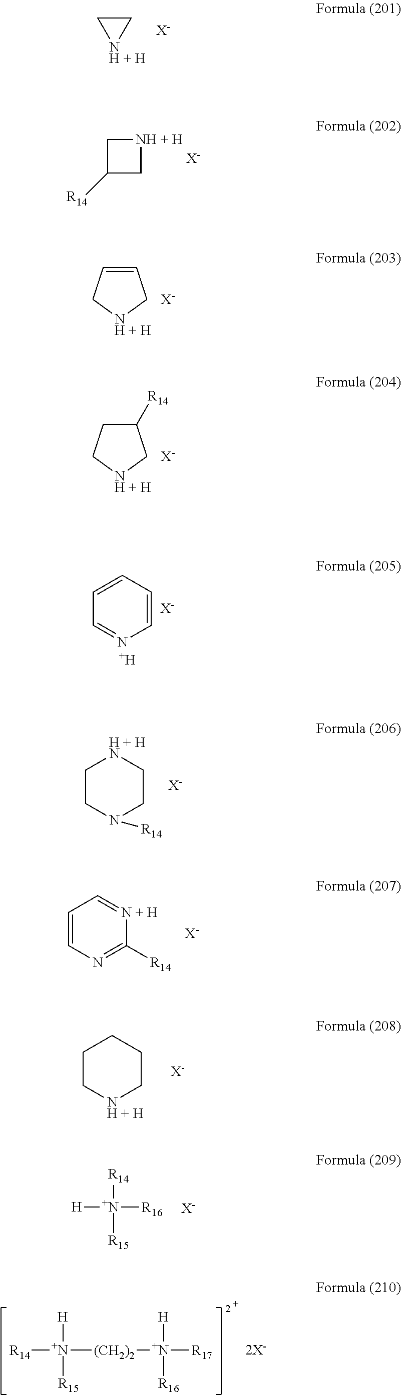

wherein X is any one of Cl⁻, Br⁻, I⁻, I3⁻, I5⁻, I7⁻, OH⁻, SO₄²⁻, HCO₃⁻, and CO₃²⁻; R₁₄, R₁₅, R₁₆ and R₁₇ are respectively one of H or a hydrocarbyl group; and the number of carbon atoms of R₁₄, R₁₅, R₁₆ and R₁₇ is in a range of 0-40.

The number of carbon atoms of R₁₄, R₁₅, R₁₆ and R₁₇ is more preferably in a range of 6-30, the number of carbon atoms of R₁₄, R₁₅, R₁₆ and R₁₇ is still more preferably in a range of 6-20, and the number of carbon atoms of R₁₄, R₁₅, R₁₆ and R₁₇ is most preferably in a range of 10-20.

When the first amine salt has the structure of Formula (209) or Formula (210), the number of carbon atoms in the backbone is preferably any integer in a range of 6-40; more preferably, the number of carbon atoms in the backbone is any integer in a range of 6-30; still more preferably, the number of carbon atoms in the backbone is any integer in a range of 6-20; and most preferably, the number of carbon atoms in the backbone is any integer in a range of 10-20.

Preferably, the second amine salt has the structure of one or more of Formula (201), Formula (202), Formula (203), Formula (204), Formula (205), Formula (206), Formula (207), Formula (208), Formula (209) and Formula (210),

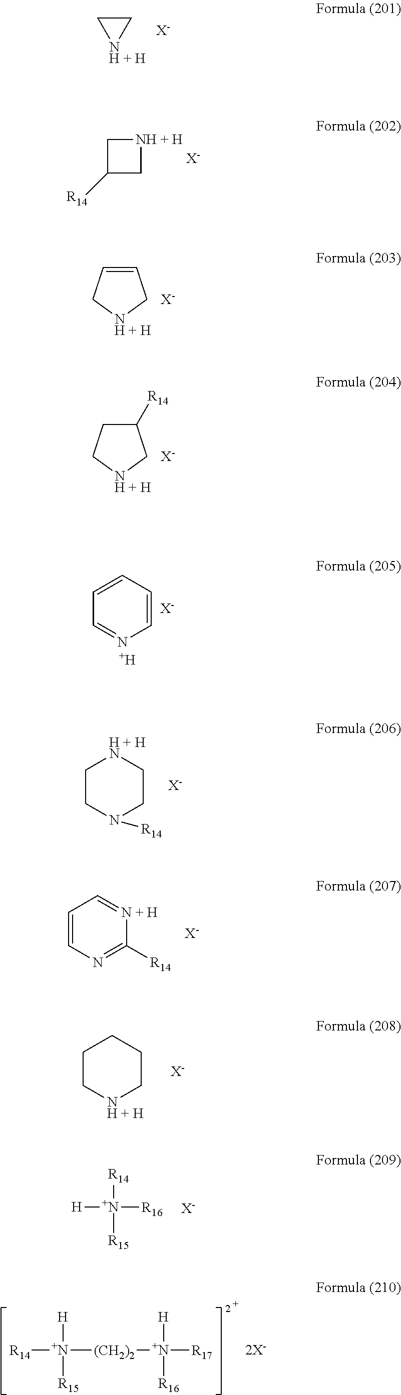

wherein X is any one of Cl⁻, Br⁻, I⁻, I3⁻, I5⁻, I7⁻, OH⁻, SO₄²⁻, HCO₃⁻, and CO₃²⁻; R₁₄, R₁₅, R₁₆ and R₁₇ are respectively one of H or a hydrocarbyl group; and the number of carbon atoms of R₁₄, R₁₅, R₁₆ and R₁₇ is in a range of 0-40.

The number of carbon atoms of R₁₄, R₁₅, R₁₆ and R₁₇ is more preferably in a range of 0-30, the number of carbon atoms of R₄, R₁, R₁₆ and R₁₇ is still more preferably in a range of 0-20, and the number of carbon atoms of R₁₄, R₁₅, R₁₆ and R₁₇ is most preferably in a range of 0-15.

When the second amine salt has the structure of Formula (209) or Formula (210), the number of carbon atoms in the backbone is any integer in a range of 1-20, more preferably any integer in a range of 1-15, and most preferably in a range of 1-10.

Preferably, the solvent C is one or any combination of water, methanol, ethanol, acetone, acetonitrile, benzene, toluene, tetrahydrofuran, dichloromethane, N,N-dimethylformamide, ethyl acetate, petroleum ether, hexane, diethyl ether and tetrachloromethane; and the solvent D is one or any combination of water, methanol, ethanol, acetone, acetonitrile, benzene, toluene, tetrahydrofuran, dichloromethane, N,N-dimethylformamide, ethyl acetate, petroleum ether, hexane, diethyl ether and tetrachloromethane.

Preferably, the preparation method further includes the following steps before step (1):

(a) preparing a water phase: mixing a sodium salt-containing aqueous solution and a dispersant, and stirring the mixture to obtain the water phase, wherein the dispersant accounts for 0.1-2.0% of the water phase by weight;

(b) preparing an oil phase: mixing a first monomer, a crosslinking agent, an initiator, and a porogen to obtain the oil phase, wherein the first monomer and the crosslinking agent form a reactant; and

(c) preparing a first resin: adding the oil phase in step (b) to the water phase in step (a), stirring and heating the mixture, controlling the temperature at 50-120° C. for reaction for 2-10 h, then controlling the temperature at 80-150° C. for reaction for 2-12 h, cooling the mixture to room temperature, extracting and washing to obtain the first resin.

Preferably, the dispersant in step (a) is one or more of hydroxyethyl cellulose, gelatin, polyvinyl alcohol, activated calcium phosphate, guar gum, methyl cellulose, sodium dodecylbenzene sulfonate and sodium lignosulfonate; the sodium salt in step (a) is one or more of trisodium phosphate, disodium hydrogen phosphate, sodium dihydrogen phosphate and sodium chloride; the crosslinking agent in step (b) is one or more of ethylene glycol diethyl diallyl ester, ethylene glycol dimethacrylate, divinylbenzene, triallyl cyanurate and trimethylolpropane trimethacrylate; the porogen in step (b) is one or more of cyclohexanol, isopropanol, n-butanol, 200 # solvent oil, toluene, xylene, ethyl acetate, n-octane and isooctane; and the initiator in step (b) is one or more of azobisisobutyronitrile and benzoyl peroxide.

Preferably, in step (b), the molar ratio of the first monomer to the crosslinking agent is 1:(0.05-0.3), the molar ratio of the first monomer to the porogen is 1:(0.1-0.5), and the weight of the initiator accounts for 0.5-1.5% of the total weight of the oil phase.

Preferably, the basic structure of the first resin is one or more of Formula (301), Formula (302), Formula (303) and Formula (304),

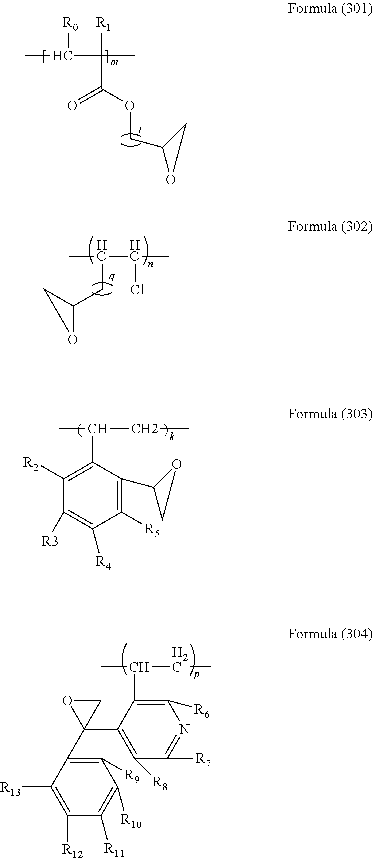

wherein R₀, R₁, R₂, R₃, R₄, R₅, R₆, R₇, R₈, R₉, R₁₀, R₁₁, R₁₂ and R₁₁ are H or hydrocarbyl groups; m, n, k and p are the number of repeating units, ranging from 500 to 3,000;

the number of carbon atoms of R₀, R₁, R₂, R₃, R₄, R₅, R₆, R₇, Ra, R₉, R₁₀, R₁₁, R₁₂ and R₁₃ is in a range of 0-30; and

when R₀, R₁, R₂, R₃, R₄, R₅, R₆, R₇, R₈, R₉, R₁₀, R₁₁, R₁₂ and R₁₃ are hydrocarbyl groups, the number of carbon atoms is preferably 1-30, more preferably 1-20, still more preferably 5-20, and most preferably 5-15.

The number of carbon atoms of t and q is in a range of 1-30, more preferably 1-20, and still more preferably 1-10.

Preferably, the first monomer has the structure of one or more of Formula (401), Formula (402), Formula (403) and Formula (404),

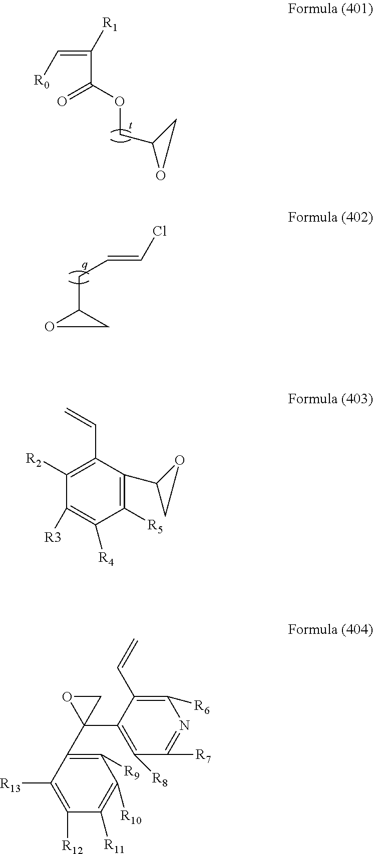

wherein R₀, R₁, R₂, R₃, R₄, R₅, R₆, R₇, R₈, R₉, R₁₀, R₁₁, R₁₂ and R₁₃ are H or hydrocarbyl groups;

the number of carbon atoms of t and q is in a range of 1-30, more preferably 1-20, and still more preferably 1-10;

the number of carbon atoms of R₀, R₁, R₂, R₃, R₄, R₅, R₆, R₇, R₈, R₉, R₁₀, R₁₁, R₁₂ and R₁₃ is in a range of 0-30; and

when R₀, R₁, R₂, R₃, R₄, R₅, R₆, R₇, R₈, R₉, R₁₀, R₁₁, R₁₂ and R₁₃ are hydrocarbyl groups, the number of carbon atoms is preferably 1-30, more preferably 1-20, still more preferably 5-20, and most preferably 5-15.

The present invention also provides an application of a composite functional resin in sterilization, and the composite functional resin is the composite functional resin obtained above.

The present invention also provides an application of a composite functional resin in water treatment, and the composite functional resin is the composite functional resin obtained above.

### 3. Beneficial Effects

Compared with the prior art, the present invention has the following beneficial effects:

(1) the composite functional resin of the present invention has a high removal rate of pathogenic bacteria in water, reaching 99.9% or more in some cases; the regenerated resin still has high bactericidal ability and long service life; in addition, the subsequent disinfection load is reduced, the amount of disinfectant used is reduced, and the operating costs are reduced;

(2) the composite functional resin of the present invention can effectively reduce the antagonistic effect of chlorine ions with the content of less than 1,000 mg/L (or equivalent multiple anions) or natural organic matter with the content of less than 3 mg/L in water on the sterilization of quaternary ammonium resins, the bactericidal efficiency of the resin is close to that of quaternary ammonium salt resin in deionized water, therefore improving the ability to resist interference of high-concentration anions such as chloride ions and high-concentration natural organic matter in water;

(3) the composite functional resin of the present invention also has a good organic matter removal rate, which can effectively remove especially the precursors of disinfection by-products, as well as various anionic pollutants such as nitrate and phosphate, and reduce various disinfection by-products generated in the subsequent disinfection process using chlorine, ozone, etc. The composite functional resin has excellent settleability, and can be used with a fluidized bed device to achieve the treatment of a large amount of water; and

(4) the present invention also provides a preparation method of the composite functional resin. The method includes mixing a first resin containing an epoxy group with a first amine salt for the first quaternization reaction, wherein by controlling the reaction conditions and the type of the first amine salt, the first quaternization reaction occurs on the outer surface of the first resin; and then adding a second amine salt to the first quaternized resin for the second quaternization reaction, wherein by controlling the reaction conditions and the type of the second amine salt, the second quaternization reaction occurs on the inner surface of the first resin, to obtain the composite functional resin of the present invention.

### BRIEF DESCRIPTION OF THE DRAWINGS

FIG. 1 shows the bactericidal efficiency of the resin A0 of a preferred example 1 of the present invention on P. aeruginosa at different Cl⁻ concentrations;

FIG. 2 shows the bactericidal efficiency of the composite functional resin A1 of a preferred example 2 of the present invention on P. aeruginosa at different Cl⁻ concentrations;

FIG. 3 shows the bactericidal efficiency of the resin A0 of the preferred example 1 of the present invention on P. aeruginosa at different natural organic matter (NOM) concentrations;

FIG. 4 shows the bactericidal efficiency of the composite functional resin A1 of the preferred example 2 of the present invention on P. aeruginosa at different NOM concentrations;

FIG. 5 shows the surface nitrogen contents and total nitrogen contents of the first quaternized resin and the second quaternized resin in a preferred example 3, a preferred example 7, a preferred example 10 and a preferred example 14 of the present invention, indicating that by controlling specific reaction conditions, the first quaternization reaction mainly occurs on the surface of the resin, and the second quaternization reaction mainly occurs inside the resin;

FIG. 6 is the infrared spectrum (FTIR) of the present invention, wherein the peak at 1105 cm⁻¹ is the C-N stretching vibration absorption peak after quaternization, a is the infrared spectrum of the first resin in example 1, b is the infrared spectrum of the resin A0 in example 1, and c is the infrared spectrum of the composite functional resin A1 in example 2.

### DETAILED DESCRIPTION

The present invention will be described in detail below with reference to the accompanying drawings.

### Example 1

Control Group

Preparation of 500 g of a water phase: 2.5 g of hydroxyethyl cellulose, 25 g of sodium sulfate and the balance of water were weighed. 500 g of the water phase was added to a 2 L three-necked flask, and the stirring speed was controlled at 300 rpm. 60 g of a first monomer was weighed, in this example, the first monomer was glycidyl methacrylate. 60 g of glycidyl methacrylate (GMA), 10 g of divinylbenzene (DVB), 0.6 g of azodiisobutyronitrile, 1.8 g of benzoyl peroxide, and 30 g of cyclohexanol were added to the three-necked flask, and the mixture was heated to 60° C. for reaction for 8 h, then heated to 90° C. for reaction for 4 h, and cooled to room temperature. White or almost white acrylic resin balls were collected, extracted, washed and air-dried, and the acrylic resin was the first resin.

The acrylic resin (with an average particle size of 500 m) was sorted. 80 g of a first amine salt was weighed, in this example, the first amine salt was dodecyldimethylamine hydrochloride. 20 g of the first resin and 80 g of dodecyldimethylamine hydrochloride were added to a 250 mL three-necked flask, the temperature was controlled at 60° C., and the mixture was stirred at 200 rpm. The solvent was the mixture of methanol and ethanol, and the methanol/ethanol volume ratio was 3:7. After 24 h of recondensation reaction, cooling and filtering, Soxhlet extraction (with methanol, ethanol or acetone), and sufficient rinsing with deionized water, the first quaternized resin was obtained. As measured, the strong base exchange capacity was 1.51 mmol/g, the surface charge density of the resin was about 1.98*10²³ N⁺/g, and the surface N content of the resin accounted for 21.8% of the total N content of the resin. The product number of the first quaternized resin was A0.

The bactericidal performance of the resin A0 obtained in this example was evaluated as follows:

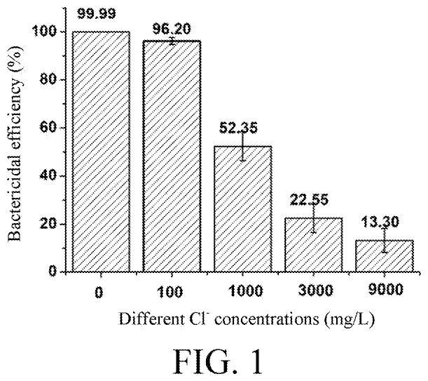

P. aeruginosa ATCC15442 was used. After being cultured in nutrient broth, the P. aeruginosa was diluted to 106 CFU/mL by Cl⁻ with the concentrations of 0 mg/L, 100 mg/L, 1,000 mg/L, 3,000 mg/L and 9,000 mg/L. 100 mL of the prepared experimental bacterial liquid was added to a 250 mL Erlenmeyer flask, 0.5 g of the resin A0 was added, and then the Erlemneyer flask was placed in a shaker at 200 rpm and 20±1° C. for 60 min. Finally, 100 μl of the bacterial liquid was separately taken to carry out spread plate counting, and the bactericidal efficiency was calculated. The evaluation result was shown in FIG. 1. When the chloride ion content was 0 mg/L, 100 mg/L, 1,000 mg/L, 3,000 mg/L and 9,000 mg/L, the corresponding bactericidal efficiency was 99.99%, 96.20%, 52.35%, 22.55% and 13.30%.

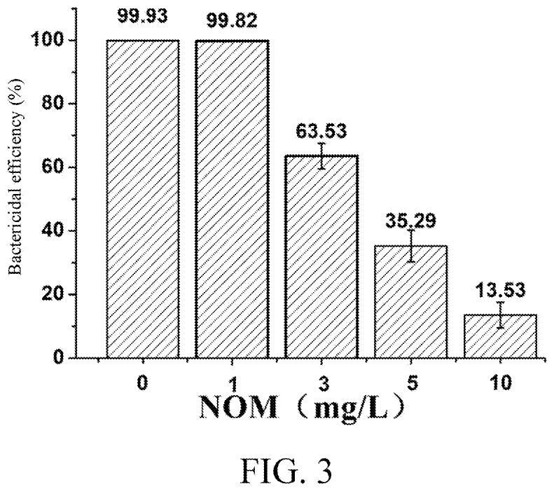

P. aeruginosa ATCC15442 was used. After being cultured in nutrient broth, the P. aeruginosa was diluted to 106 CFU/mL by NOM with the concentrations of 0 mg/L, 1 mg/L, 3 mg/L, 5 mg/L and 10 mg/L. 100 mL of the prepared experimental bacterial liquid was added to a 250 mL Erlenmeyer flask, 0.5 g of the resin A0 was added, and then the Erlenmeyer flask was placed in a shaker at 200 rpm and 20±1° C. for 60 min. Finally, 100 μl of the bacterial liquid was separately taken to carry out spread plate counting, and the bactericidal efficiency was calculated. The evaluation result was shown in FIG. 3. When the NOM concentration was 0 mg/L, 1 mg/L, 3 mg/L, 5 mg/L and 10 mg/L, the corresponding bactericidal efficiency was 99.93%, 99.82%, 63.53%, 35.29% and 13.52%.

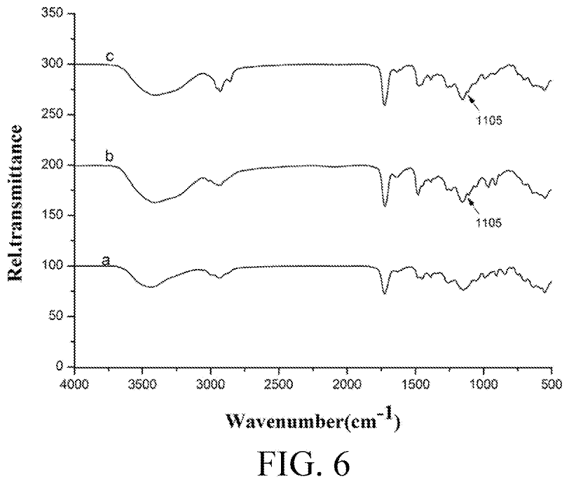

As shown in FIG. 6, a is the infrared spectrum of the first resin of this example, and b is the infrared spectrum of the resin A0 of this example.

NOM mainly refers to organic matters widely distributed in nature, such as oil, sugar, protein, natural rubber, etc. Since these substances are organic compounds synthesized in vivo, they are referred to as natural organic matters.

### Example 2

Preparation of 500 g of a water phase: 2.5 g of hydroxyethyl cellulose, 25 g of sodium sulfate and the balance of water were weighed.

500 g of the water phase was added to a 2 L three-necked flask, and the stirring speed was controlled at 300 rpm. 60 g of a first monomer was weighed, in this example, the first monomer was glycidyl methacrylate. 60 g of glycidyl methacrylate (GMA), 10 g of divinylbenzene (DVB), 0.6 g of azodiisobutyronitrile, 1.8 g of benzoyl peroxide, and 30 g of cyclohexanol were added to the three-necked flask, and the mixture was heated to 60° C. for reaction for 8 h, then heated to 90° C. for reaction for 4 h, and cooled to room temperature. White or almost white resin balls were collected, extracted, washed and air-dried to obtain the first resin.

The first resin (with an average particle size of 500 μm) was sorted. 80 g of a first amine salt was weighed, in this example, the first amine salt was dodecyldimethylamine hydrochloride. 20 g of the first resin and 80 g of dodecyldimethylamine hydrochloride were added to a 250 mL three-necked flask, the temperature was controlled at 60° C., and the mixture was stirred at 400 rpm. The solvent was the mixture of methanol and ethanol, and the methanol/ethanol volume ratio was 3:7. After 24 h of recondensation reaction, cooling to room temperature, filtering, and rinsing respectively twice with absolute ethanol and deionized water, the first quaternized resin was obtained with the product number of A1-1 and a total weight of 21.05 g. The first quaternized resin was added to a cleaned 250 mL three-necked flask, and a second amine salt was added, in this example, the second amine salt was triethylamine hydrochloride. 60 g of triethylamine hydrochloride was added, the solvent was 40% ethanol, the temperature was controlled at 70° C., and the mixture was stirred at 250 rpm. After 30 h of recondensation reaction, cooling and filtering, Soxhlet extraction (with methanol, ethanol or acetone), and sufficient rinsing with deionized water, the composite functional resin of the present invention was obtained. As measured, the strong base exchange capacity was 2.15 mmol/g, the surface charge density of the composite functional resin was about 2.08*10² N⁺/g, and the surface N content of the composite functional resin accounted for 16.1% of the total N content of the composite functional resin. The product number of the composite functional resin was A1, totaling 22.50 g.

The number of repeating units of the composite functional resin in this example was in a range of 2,700-3,000.

As shown in FIG. 6, c is the infrared spectrum of the composite functional resin A1 of this example.

The bactericidal performance of the composite functional resin A1 obtained in this example was evaluated as follows:

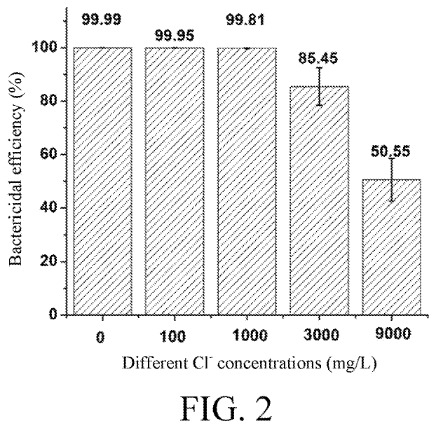

P. aeruginosa ATCC15442 was used. After being cultured in nutrient broth, the P. aeruginosa was diluted to 10⁶ CFU/mL by Cl⁻ with the concentrations of 0 mg/L, 100 mg/L, 1,000 mg/L, 3,000 mg/L and 9,000 mg/L. 100 mL of the prepared experimental bacterial liquid was added to a 250 mL Erlenmeyer flask, 0.5 g of the resin A1 was added, and then the Erlenmeyer flask was placed in a shaker at 200 rpm and 20±1° C. for 60 min. Finally, 100 μl of the bacterial liquid was separately taken to carry out spread plate counting, and the bactericidal efficiency was calculated. The evaluation result was shown in FIG. 2. When the chloride ion content was 0 mg/L, 100 mg/L, 1,000 mg/L, 3,000 mg/L and 9,000 mg/L, the corresponding bactericidal efficiency was 99.99%, 99.95%, 99.81%, 85.45% and 50.55%.

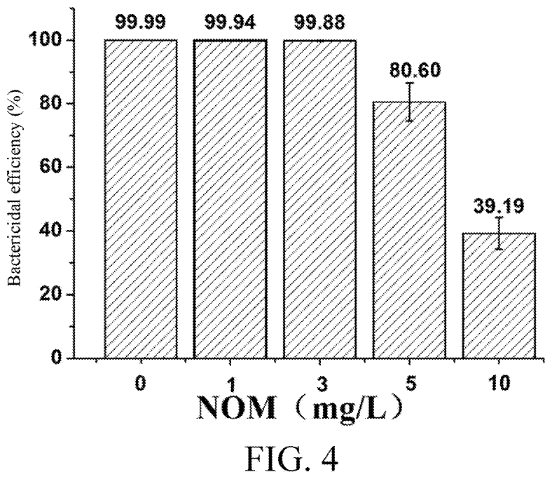

P. aeruginosa ATCC15442 was used. After being cultured in nutrient broth, the P. aeruginosa was diluted to 10⁶ CFU/mL by NOM with the concentrations of 0 mg/L, 1 mg/L, 3 mg/L, 5 mg/L and 10 mg/L. 100 mL of the prepared experimental bacterial liquid was added to a 250 mL Erlenmeyer flask, 0.5 g of the resin A1 was added, and then the Erlenmeyer flask was placed in a shaker at 200 rpm and 20±1° C. for 60 min. Finally, 100 μL of the bacterial liquid was separately taken to carry out spread plate counting, and the bactericidal efficiency was calculated. The evaluation result was shown in FIG. 4. When the NOM concentration was 0 mg/L, 1 mg/L, 3 mg/L, 5 mg/L and 10 mg/L, the corresponding bactericidal efficiency was 99.99%, 99.94%, 99.88%, 80.60% and 39.19%.

### Example 3

The first monomer of this example had the structure of Formula (401), and when R₀ was H, R₁ was —CH₃, and t=1, the first monomer had the structure of Formula (401-1):

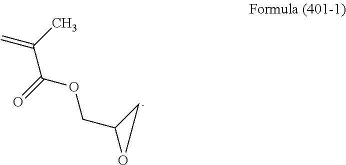

The specific implementation was as follows:

Preparation of 500 g of a water phase: 2.5 g of methyl cellulose, 5 g of sodium dodecylbenzene sulfonate, 50 g of sodium sulfate and the balance of water were weighed.

500 g of the water phase was added to a 2 L three-necked flask. and the stirring speed was controlled at 400 rpm. 40 g of the first monomer having the structure of Formula (401-1), 20 g of methyl acrylate (MA), 20 g of styrene, 5 g of ethylene glycol dimethacrylate, 10 g of trimethylolpropane trimethacrylate, 1.0 g of azodiisobutyronitrile, 10 g of 200 # solvent oil and 10 g of n-butanol were added to the three-necked flask, and the mixture was heated to 50° C. for reaction for 12 h, then heated to 80° C. for reaction for 4 h, and cooled to room temperature. White or almost white resin balls were collected, extracted, washed and air-dried to obtain the first resin.

The first resin (with an average particle size of 500 μm) was sorted. 80 g of a first amine salt was weighed, in this example, the first amine salt was N,N-dimethyloctylamine hydrochloride. 20 g of the first resin and 120 g of N,N-dimethyloctylamine hydrochloride were added to a 250 mL three-necked flask, the temperature was controlled at 70° C., and the mixture was stirred at 300 rpm. The solvent was N,N-dimethyl formamide. After 30 h of recondensation reaction, cooling to room temperature, filtering, and rinsing respectively twice with absolute ethanol and deionized water, the first quaternized resin was obtained with the product number of A2-1 and a total weight of 21.30 g. The first quaternized resin was added to a cleaned 250 mL three-necked flask, and a second amine salt was added, in this example, the second amine salt was trimethylamine hydrochloride. 50 g of trimethylamine hydrochloride was added, the solvent was acetonitrile, the temperature was controlled at 70° C., and the mixture was stirred at 300 rpm. After 24 h of recondensation reaction, cooling and filtering, Soxhlet extraction (with methanol, ethanol or acetone), and sufficient rinsing with deionized water, the composite functional resin of the present invention was obtained.

As measured, the strong base exchange capacity was 2.25 mmol/g, the surface charge density of the composite functional resin was about 2.72*10² N⁺/g, and the surface N content of the composite functional resin accounted for 20.0% of the total N content of the composite functional resin. The product number of the composite functional resin was A2, totaling 21.80 g.

The number of repeating units of the composite functional resin in this example was in a range of 2,500-2,700.

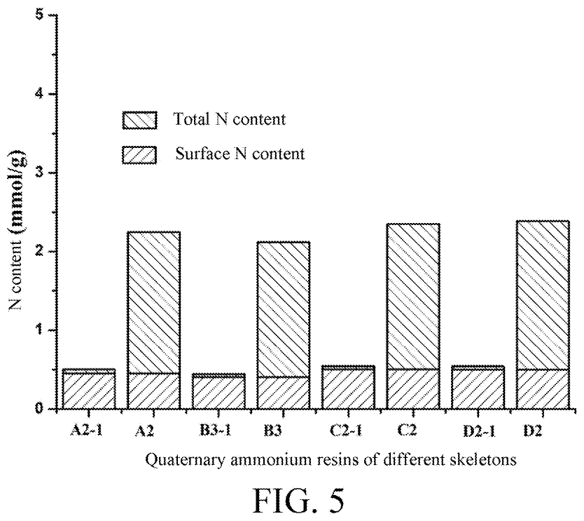

As shown in FIG. 5, the surface nitrogen contents and total nitrogen contents of the first quaternized resin A2-1 and the composite functional resin A2 were respectively measured. It can be seen that, in this example, the first quaternization reaction mainly occurred on the surface of the resin, and the second quaternization reaction mainly occurred inside the resin.

### Example 4

The first monomer of this example had the structure of Formula (401), and when R₀ was —CH₂CH₃, R₁ was —CH₃, and t=2, the first monomer had the structure of Formula (401-2):

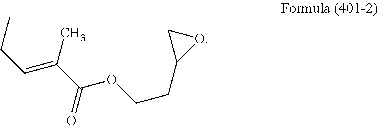

The first amine salt had the structure of Formula (205), and when X⁻ was Cl⁻, the first amine salt had the structure of Formula (205-1):

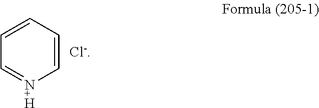

The second amine salt had the structure of Formula (201), and when X⁻ was Cl⁻, the second amine salt had the structure of Formula (201-1):

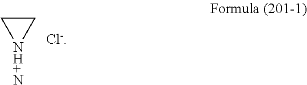

The specific implementation was as follows:

Preparation of 500 g of a water phase: 2.5 g of gelatin, 2.5 g of guar gum, 50 g of sodium sulfate, 50 g of sodium chloride and the balance of water were weighed.

500 g of the water phase was added to a 2 L three-necked flask, and the stirring speed was controlled at 280 rpm. 50 g of a first monomer having the structure of Formula (401-2), 20 g of butyl acrylate, 10 g of MA, 1 g of ethylene glycol dimethacrylate, 1.5 g of benzoyl peroxide, 10 g of toluene, 15 g of xylene and 10 g of normal octane were added to the three-necked flask, and the mixture was heated to 105° C. for reaction for 12 h, then heated to 130° C. for reaction for 4 h, and cooled to room temperature. White or almost white acrylic resin balls were collected, extracted, washed and air-dried to obtain the acrylic resin as the first resin.

The first resin (with a particle size of 10 μm) was sorted. 20 g of the first resin and 100 g of a first amine salt were added to a 250 mL three-necked flask, in this example, the first amine salt had the structure of Formula (205-1). The temperature was controlled at 85° C., and the mixture was stirred at 400 rpm. The solvent was toluene. After 24 h of recondensation reaction, cooling to room temperature, filtering, and rinsing respectively twice with absolute ethanol and deionized water, the first quaternized resin was obtained with the product number of A3-1 and a total weight of 20.85 g. The first quaternized resin was added to a cleaned 250 mL three-necked flask, 50 g of a second amine salt was added, wherein the second amine salt had the structure of Formula (201-1). The solvent was ethane, the temperature was controlled at 60° C., and the mixture was stirred at 480 rpm. After 40 h of recondensation reaction, cooling and filtering, Soxhlet extraction (with methanol, ethanol or acetone), and sufficient rinsing with deionized water, the composite functional resin of the present invention was obtained. As measured, the strong base exchange capacity was 0.33 mmol/g, the surface charge density of the composite functional resin was about 2.01*10¹⁹ N⁺/g, and the surface N content of the composite functional resin accounted for 10.12% of the total N content of the composite functional resin. The product number of the composite functional resin was A3, totaling 21.50 g.

When X⁻ of the composite functional resin A3 was any one of Br, I⁻, I3⁻, I5⁻, I7⁻, OH⁻, SO₄²⁻, HCO₃₋ and CO₃²⁻, similar effects can be achieved.

The number of repeating units of the composite functional resin in this example was in a range of 2,000-2,500.

### Example 5

The first monomer of this example had the structure of Formula (403), and when R₂ was —H, R₃ was —CH₃, R₄ was —H, and R₅ was —H, the first monomer had the structure of Formula (403-1):

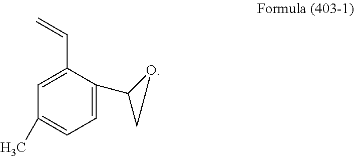

The first amine salt in this example had the structure of Formula (208), and when X was I⁻, the first amine salt had the structure of Formula (208-1):

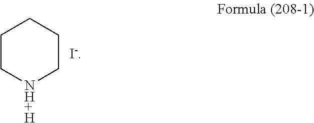

The second amine salt in this example had the structure of Formula (202), and when R₁₄ was —CH₃, and X⁻ was Cl⁻, the second amine salt had the structure of Formula (202-2):

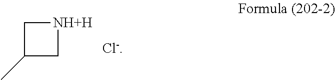

The specific implementation was as follows:

Preparation of 500 g of a water phase: 2.5 g of polyvinyl alcohol, 15 g of sodium chloride and the balance of water were weighed.

500 g of the water phase was added to a 2 L three-necked flask, and the stirring speed was controlled at 200 rpm. 45 g of a first monomer having the structure of Formula (403-1), 35 g of divinylbenzene (DVB), 5 g of toluene, 5 g of n-heptane, 5 g of cyclohexanol and 0.5 g of azodiisobutyronitrile (AIBN) were added to the three-necked flask, and the mixture was heated to 55° C. for reaction for 12 h, then heated to 75° C. for reaction for 12 h, and cooled to room temperature. White or almost white resin balls were collected, extracted, washed and air-dried to obtain the first resin.

The first resin (with an average particle size of 2,000 μm) was sorted. 20 g of the first resin and 80 g of a compound having the structure of Formula (208-1) were added to a 250 mL three-necked flask, the temperature was controlled at 70° C., and the mixture was stirred at 250 rpm. The solvent was tetrachloromethane. After 10 h of recondensation reaction, cooling to room temperature, filtering, and rinsing respectively twice with absolute ethanol and deionized water, the first quaternized resin was obtained with the product number of B1-1 and a total weight of 20.90 g. The first quaternized resin was added to a cleaned 250 mL three-necked flask, 80 g of the compound having the structure of Formula (202-2) was added, the solvent was ethyl acetate, the temperature was controlled at 65° C., and the mixture was stirred at 300 rpm. After 40 h of recondensation reaction, cooling and filtering, Soxhlet extraction (with methanol, ethanol or acetone), and sufficient rinsing with deionized water, the composite functional resin of the present invention was obtained. As measured, the strong base exchange capacity was 0.3073 mmol/g, the surface charge density of the composite functional resin was about 9.01*10¹⁵ N⁺/g, and the surface N content of the composite functional resin accounted for 0.005% of the total N content of the composite functional resin. The product number of the composite functional resin was B1, totaling 21.59 g.

The number of repeating units of the composite functional resin in this example was in a range of 1,500-2,000.

### Example 6

The first monomer of this example consists of two different types of first monomers.

The first type of first monomer had the structure of Formula (403), and when R₂ was —CH₃, R₃ was —CH₃, R₄ was —H, and R₅ was —H, the first type of first monomer had the structure of Formula (403-2):

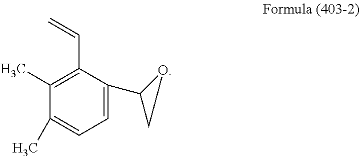

The second type of first monomer was glycidyl methacrylate (GMA).

The first amine salt in this example was N,N′-dibenzylethylenediamine hydrochloride.

The second amine salt in this example had the structure of Formula (203), and when X⁻ was Cl⁻, the second amine salt had the structure of Formula (203-1):

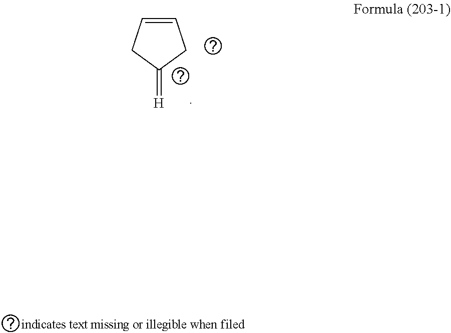

The specific implementation was as follows:

Preparation of 500 g of a water phase: 2.5 g of polyvinyl alcohol, 1.5 g of hydroxyethyl cellulose, 25 g of sodium chloride and the balance of water were weighed.

500 g of the water phase was added to a 2 L three-necked flask, and the stirring speed was controlled at 300 rpm. 40 g of a compound having the structure of Formula (403-2), 20 g of glycidyl methacrylate (GMA), 15.0 g of divinylbenzene (DVB), 10 g of toluene, 10 g of xylene, 10 g of cyclohexanol, 0.5 g of benzoyl peroxide and 0.25 g of azodiisobutyronitrile were added to the three-necked flask, and the mixture was heated to 65° C. for reaction for 12 h, then heated to 75° C. for reaction for 8 h, and cooled to room temperature. White or almost white resin balls were collected, extracted, washed and air-dried to obtain the first resin.

The first resin (with an average particle size of 100 μm) was sorted. 20 g of the first resin and 50 g of N,N′-dibenzylethylenediamine hydrochloride were added to a 250 mL three-necked flask, the temperature was controlled at 110° C., and the mixture was stirred at 280 rpm. The solvent was toluene. After 24 h of recondensation reaction, cooling to room temperature, filtering, and rinsing respectively twice with absolute ethanol and deionized water, the first quaternized resin was obtained with the product number of B2-1 and a total weight of 21.51 g. The first quaternized resin was added to a cleaned 250 mL three-necked flask, 80 g of a second amine salt was added, the solvent was ethanol, the temperature was controlled at 70° C., and the mixture was stirred at 380 rpm. After 30 h of recondensation reaction, cooling and filtering, Soxhlet extraction (with methanol, ethanol or acetone), and sufficient rinsing with deionized water, the composite functional resin of the present invention was obtained. As measured, the strong base exchange capacity was 1.46 mmol/g, the surface charge density of the composite functional resin was about 1.39*10²³N⁺/g, and the surface N content of the composite functional resin accounted for 15.8% of the total N content of the composite functional resin. The product number of the composite functional resin was B2, totaling 22.19 g.

The number of repeating units of the composite functional resin in this example was in a range of 2,000-2,300.

When X⁻ of the composite functional resin B2 was any one of Br, I⁻, I3⁻, I5⁻, I7⁻, OH⁻, SO₄²⁻, HCO₃⁻ and CO₃²⁻, similar effects can also be achieved.

### Example 7

The first monomer of this example had the structure of Formula (403), and when R₂ was —H, R₃ was —CH₃, R₄ was —CH₂CH₃, and R₅ was —H, the first monomer had the structure of Formula (403-3):

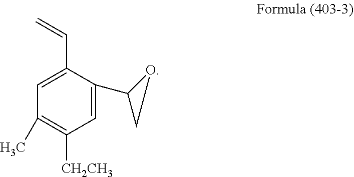

The first amine salt in this example was N,N-dimethyl-n-octylamine hydrochloride, and the second anine salt in this example was trimethylamine hydrochloride.

The specific implementation was as follows:

Preparation of 500 g of a water phase: 2.5 g of methyl cellulose, 2.5 g of hydroxyethyl cellulose, 25 g of sodium sulfate, 25 g of sodium chloride and the balance of water were weighed.

500 g of the water phase was added to a 2 L three-necked flask, and the stirring speed was controlled at 250 rpm. 40 g of a compound having the structure of Formula (403-3), 10 g of methyl acrylate (MA), 5 g of butyl acrylate, 10 g of ethylene glycol dimethacrylate, 10 g of ethylene glycol dimethacrylate, 10 g of 200 # solvent oil, 10 g of n-butanol, 5 g of cyclohexanol and 1.0 g of azodiisobutyronitrile were added to the three-necked flask, and the mixture was heated to 80° C. for reaction for 12 h, then heated to 90° C. for reaction for 8 h, and cooled to room temperature. White or almost white resin balls were collected, extracted, washed and air-dried to obtain the first resin.

The first resin (with an average particle size of 500 un) was sorted. 20 g of the first resin and 100 g of N,N-dimethyl-n-octylamine hydrochloride were added to a 250 mL three-necked flask, the temperature was controlled at 60° C., and the mixture was stirred at 380 rpm. The solvent was ethanol. After 40 h of recondensation reaction, cooling to room temperature, filtering, and rinsing respectively twice with absolute ethanol and deionized water, the first quaternized resin was obtained with the product number of B3-1 and a total weight of 21.35 g. The first quaternized resin was added to a cleaned 250 mL three-necked flask, 60 g of trimethylamine hydrochloride was added, the solvent was methanol, the temperature was controlled at 70° C., and the mixture was stirred at 300 rpm. After 24 h of recondensation reaction, cooling and filtering, Soxhlet extraction (with methanol, ethanol or acetone), and sufficient rinsing with deionized water, the composite functional resin of the present invention was obtained. As measured, the strong base exchange capacity was 2.12 mmol/g, the surface charge density of the composite functional resin was about 2.44*10²³ N⁺/g, and the surface N content of the composite functional resin accounted for 19.1% of the total N content of the composite functional resin. The product number of the composite functional resin is B3, totaling 22.90 g.

The number of repeating units of the composite functional resin in this example was in a range of 500-1,000.

As shown in FIG. 5, the surface nitrogen contents and total nitrogen contents of the first quaternized resin B3-1 and the composite functional resin B3 were respectively measured. It can be seen that, in this example, the first quaternization reaction mainly occurred on the surface of the resin, and the second quaternization reaction mainly occurred inside the resin.

### Example 8

The first monomer of this example consists of two different types of first monomers.

The first type of first monomer had the structure of Formula (403), and when R₂ was —H, R₃ was —CH₃, R₄ was —H, and R₅ was —H, the first type of first monomer had the structure of Formula (403-1):

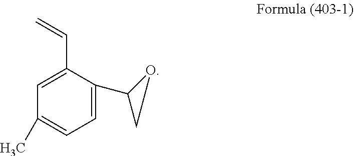

The second type of first monomer was glycidyl methacrylate (GMA).

The first amine salt in this example was dioctadecylmethylamine hydrochloride, and the second amine salt in this example was trimethylamine hydrochloride.

The specific implementation was as follows:

Preparation of 500 g of a water phase: 1.25 g of guar gum, 1.25 g of sodium lignosulfonate, 25 g of sodium sulfate, 15 g of sodium bicarbonate and the balance of water were weighed.

500 g of the water phase was added to a 2 L three-necked flask, and the stirring speed was controlled at 280 rpm. 30 g of a compound having the structure of Formula (403-1), 10 g of GMA, 10 g of MA, 10 g of trimethylolpropane trimethacrylate, 10 g of triallyl cyanurate, 10 g of 200 # solvent oil, 5 g of isooctane, 5 g of isopropanol and 1.5 g of benzoyl peroxide were added to the three-necked flask, and the mixture was heated to 70° C. for reaction for 12 h, then heated to 95° C. for reaction for 8 h, and cooled to room temperature. White or almost white resin balls were collected, extracted, washed and air-dried to obtain the first resin.

The first resin (with an average particle size of 10 μm) was sorted. 20 g of the first resin and 100 g of tetramethyl ethylene diamine hydrochloride were added to a 250 mL three-necked flask, the temperature was controlled at 120° C., and the mixture was stirred at 340 rpm. The solvent was N,N-dimethylformamide. After 40 h of recondensation reaction, cooling to room temperature, filtering, and rinsing respectively twice with absolute ethanol and deionized water, the first quaternized resin was obtained with the product number of B4-1 and a total weight of 21.20 g. The first quaternized resin was added to a cleaned 250 mL three-necked flask, 80 g of trimethylamine hydrochloride was added, the solvent was tetrachloromethane, the temperature was controlled at 70° C., and the mixture was stirred at 300 rpm. After 40 h of recondensation reaction, cooling and filtering, Soxhlet extraction (with methanol, ethanol or acetone), and sufficient rinsing with deionized water, the composite functional resin of the present invention was obtained. As measured, the strong base exchange capacity was 3.99 mmol/g, the surface charge density of the composite functional resin was about 1.20*10²⁴ N⁺/g, and the surface N content of the composite functional resin accounted for 49.87% of the total N content of the composite functional resin. The product number of the composite functional resin was B4, totaling 22.75 g.

The number of repeating units of the composite functional resin in this example was in a range of 1,200-1,800.

### Example 9

The first monomer of this example had the structure of Formula (402), and when q=1, the first monomer had the structure of Formula (402-1):

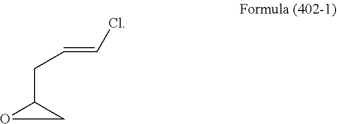

The first amine salt in this example was cetyl dimethylamine salt, and the second amine salt in this example was tripropylamine hydrochloride.

The specific implementation was as follows:

Preparation of 500 g of a water phase: 2.5 g of polyvinyl alcohol, 5 g of ammonium bicarbonate and the balance of water were weighed.

500 g of the water phase was added to a 2 L three-necked flask, and the stirring speed was controlled at 250 rpm. 100 g of a first monomer, 8 g of ethylene glycol dimethacrylate (EGDM), 40 g of toluene, 0.5 g of azobisisobutyronitrile, 0.5 g of dicyclohexyl peroxydicarbonate, 2 g of calcium stearate and 20 g of white oil were added to the three-necked flask, and the mixture was heated to 60° C. for reaction for 10 h, then heated to 80° C. for reaction for 6 h, and cooled to room temperature. The toluene and white oil were removed, the first resin was obtained.

The first resin (with an average particle size of 100 μm) was sorted. 20 g of the first resin and 80 g of cetyl dimethylamine salt were added to a 250 mL three-necked flask, the temperature was controlled at 100° C., and the mixture was stirred at 280 rpm. The solvent was toluene. After 30 h of recondensation reaction, cooling to room temperature, filtering, and rinsing respectively twice with absolute ethanol and deionized water, the first quaternized resin was obtained with the product number of C1-1 and a total weight of 21.80 g. The first quaternized resin was added to a cleaned 250 mL three-necked flask, 80 g of tripropylamine hydrochloride was added, the solvent was tetrachloromethane, the temperature was controlled at 70° C., and the mixture was stirred at 300 rpm. After 40 h of recondensation reaction, cooling and filtering, Soxhlet extraction (with methanol, ethanol or acetone), and sufficient rinsing with deionized water, the composite functional resin of the present invention was obtained. As measured, the strong base exchange capacity was 1.90 mmol/g, the surface charge density of the composite functional resin was about 2.16*10²³ N⁺/g, and the surface N content of the composite functional resin accounted for 18.9% of the total N content of the composite functional resin. The product number of the composite functional resin was Cl⁻, totaling 22.55 g.

The number of repeating units of the composite functional resin in this example was in a range of 1,000-1,600.

### Example 10

The first monomer of this example consists of two different types of first monomers.

The first type of first monomer had the structure of Formula (402), and when q=2, the first type of first monomer had the structure of Formula (402-2):

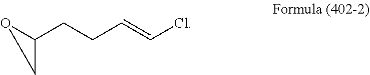

The second type of first monomer was glycidyl methacrylate (GMA).

The first amine salt in this example was N,N-dimethylhexylamine hydrochloride, and the second amine salt in this example was trimethylamine hydrochloride.

The specific implementation was as follows:

Preparation of 500 g of a water phase: 1.5 g of polyvinyl alcohol, 1.5 g of hydroxyethyl cellulose, 5 g of ammonium bicarbonate and the balance of water were weighed.

500 g of the water phase was added to a 2 L three-necked flask, and the stirring speed was controlled at 350 rpm. 80 g of a compound having the structure of Formula (402-2), 20 g of GMA, 10 g of triallyl isocyanurate, 20 g of toluene, 10 g of xylene, 0.5 g of dicyclohexyl peroxydicarbonate, 0.5 g of azodiisobutyronitrile, 2 g of zinc stearate and 30 g of white oil were added to the three-necked flask, and the mixture was heated to 56° C. for reaction for 10 h, then heated to 75° C. for reaction for 8 h, and cooled to room temperature. The toluene, xylene and white oil were removed, and the first resin was obtained.

The first resin (with an average particle size of 500 μm) was sorted. 20 g of the first resin and 40 g of N,N-dimethylhexylamine hydrochloride were added to a 250 mL three-necked flask, the temperature was controlled at 70° C., and the mixture was stirred at 450 rpm. The solvent was ethanol. After 20 h of recondensation reaction, cooling to room temperature, filtering, and rinsing respectively twice with absolute ethanol and deionized water, the first quaternized resin was obtained with the product number of C2-1 and a total weight of 21.89 g. The first quaternized resin was added to a cleaned 250 mL three-necked flask, 70 g of trimethylamine hydrochloride was added, the solvent was methanol, the temperature was controlled at 70° C., and the mixture was stirred at 300 rpm. After 24 h of recondensation reaction, cooling and filtering, Soxhlet extraction (with methanol, ethanol or acetone), and sufficient rinsing with deionized water, the composite functional resin of the present invention was obtained. As measured, the strong base exchange capacity was 2.35 mmol/g, the surface charge density of the composite functional resin was about 3.04*10²³ N⁺/g, and the surface N content of the composite functional resin accounted for 21.5% of the total N content of the composite functional resin. The product number of the composite functional resin was C2, totaling 23.05 g.

As shown in FIG. 5, the surface nitrogen content and total nitrogen content of the first quaternized resin C2-1 and the composite functional resin C2 were respectively measured. It can be seen that, in this example, the first quaternization reaction mainly occurred on the surface of the resin, and the second quaternization reaction mainly occurred inside the resin.

### Example 11

The first monomer of this example consists of two different types of first monomers.

The first type of first monomer had the structure of Formula (402), and when q=3, the first type of first monomer had the structure of Formula (402-3):

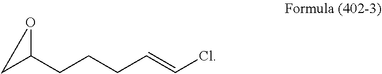

The second type of first monomer was glycidyl methacrylate (GMA).

The first amine salt in this example had the structure of Formula (206), and when R₁₄ was —H, and X was Cl⁻, the first amine salt had the structure of Formula (206-1):

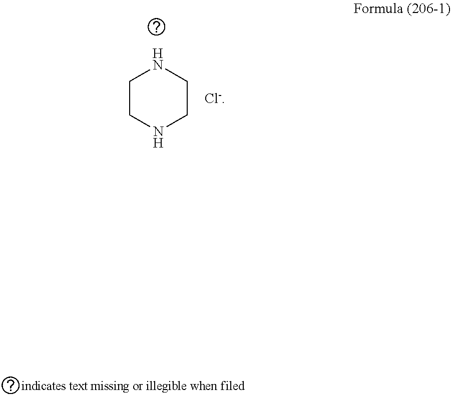

The second amine salt in this example had the structure of Formula (202), when R₁₄ was —H, and X was Cl⁻, the second amine had the structure of Formula (202-1):

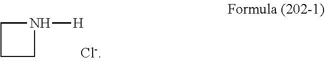

The specific implementation was as follows:

Preparation of 500 g of a water phase: 2.5 g of guar gum, 5 g of sodium dodecylbenzene sulfonate, 5 g of ammonium bicarbonate and the balance of water were weighed.

500 g of the water phase was added to a 2 L three-necked flask, and the stirring speed was controlled at 280 rpm. 60 g of the compound having the structure of Formula (402-3), 30 g of GMA, 10 g of MA, 13 g of N,N-methylene bisacrylamide, 20 g of 200 # solvent oil, 10 g of n-butanol, 0.5 g of benzoyl peroxide, 0.3 g of azobisisobutyronitrile, 2 g of calcium sebacate and 15 g of white oil were added to the three-necked flask, and the mixture was heated to 65° C. for reaction for 10 h, then heated to 90° C. for reaction for 6 h, and cooled to room temperature. The 200 # solvent oil, n-butanol and white oil were removed, and the first resin was obtained.

The first resin (with an average particle size of 200 μm) was sorted. 20 g of the first resin and 100 g of a first amine salt were added to a 250 mL three-necked flask, the temperature was controlled at 120° C., and the mixture was stirred at 350 rpm. The solvent was N,N-dimethylfomamide. After 30 h of recondensation reaction, cooling to room temperature, filtering, and rinsing respectively twice with absolute ethanol and deionized water, the first quaternized resin was obtained with the product number of C3-1 and a total weight of 21.15 g. The first quaternized resin was added to a cleaned 250 mL three-necked flask, 40 g of a second amine salt was added, the solvent was ethyl acetate, the temperature was controlled at 70° C., and the mixture was stirred at 300 rpm. After 40 h of recondensation reaction, cooling and filtering, Soxhlet extraction (with one or any combination of methanol, ethanol and acetone), and sufficient rinsing with deionized water, the composite functional resin of the present invention was obtained. As measured, the strong base exchange capacity was 1.68 mmol/g, the surface charge density of the composite functional resin was about 1.71*10²³ N⁺/g, and the surface N content of the composite functional resin accounted for 16.9% of the total N content of the composite functional resin. The product number was C3, totaling 21.85 g.

When X⁻ of the first amine salt and the second amine salt was any one of Br, I⁻, I3⁻, I5⁻, I7⁻, OH⁻, SO₄²⁻, HCO₃⁻ and CO₃²⁻, similar effects can also be achieved.

### Example 12

The first monomer of this example consists of two different types of first monomers.

The first type of first monomer had the structure of Formula (402), and when q=4, the first type of first monomer had the structure of Formula (402-4):

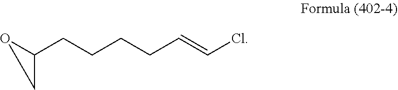

The second type of first monomer was glycidyl methacrylate (GMA).

The first amine salt in this example had the structure of Formula (204), and when R₁₄ was —H, and X was Cl⁻, the first amine salt had the structure of Formula (204-1):

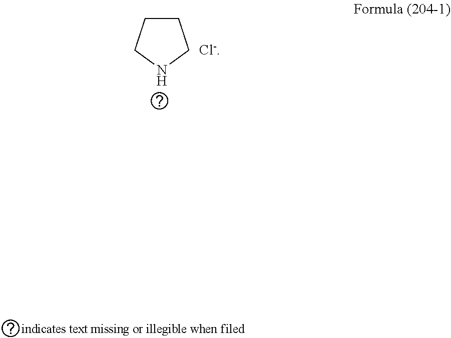

The second amine salt in this example was triethylamine hydrochloride.

The specific implementation was as follows:

Preparation of 500 g of a water phase: 2.5 g of guar gun, 1.5 g of activated calcium phosphate, 7.5 g of ammonium bicarbonate and the balance of water were weighed.

500 g of the water phase was added to a 2 L three-necked flask, and the stirring speed was controlled at 450 rpm. 60 g of the compound having the structure of Formula (402-4), 20 g of GMA, 20 g of methyl acrylate, 20 g of butyl acrylate, 13 g of N,N-methylene bisacrylamide, 5 g of ethylene glycol dimethacrylate, 15 g of isooctane, 10 g of n-octane, 0.5 g of benzoyl peroxide, 0.5 g of dicyclohexyl peroxydicarbonate, 2 g of calcium laurate and 25 g of white oil were added to the three-necked flask, and the mixture was heated to 80° C. for reaction for 10 h, then heated to 110° C. for reaction for 12 h, and cooled to room temperature. The isooctane, n-octane and white oil were removed, and the first resin was obtained.

The first resin (with an average particle size of 600 μm) was sorted. 20 g of the first resin and 100 g of a compound having the structure of Formula (204-1) were added to a 250 mL three-necked flask, the temperature was controlled at 70° C., and the mixture was stirred at 250 rpm. The solvent was toluene. After 24 h of recondensation reaction, cooling to room temperature, filtering, and rinsing respectively twice with absolute ethanol and deionized water, the first quaternized resin was obtained with the product number of C4-1 and a total weight of 20.85 g. The first quaternized resin was added to a cleaned 250 mL three-necked flask, 60 g of triethylamine hydrochloride was added, the solvent was methanol, the temperature was controlled at 70° C., and the mixture was stirred at 250 rpm. After 30 h of recondensation reaction, cooling and filtering, Soxhlet extraction (with methanol, ethanol or acetone), and sufficient rinsing with deionized water, the composite functional resin of the present invention was obtained. As measured, the strong base exchange capacity was 1.87 mmol/g, the surface charge density of the composite functional resin was about 2.13*10²³ N⁺/g, and the surface N content of the composite functional resin accounted for 18.9% of the total N content of the composite functional resin. The product number of the composite functional resin was C4, totaling 21.60 g.

### Example 13

The first monomer of this example had the structure of Formula (404), and when R₆, R₇, R₈, R₉, R₁₀, R₁₁, R₁₂ and R₁₃ were H, the first monomer had the structural formula of Formula (404-1):

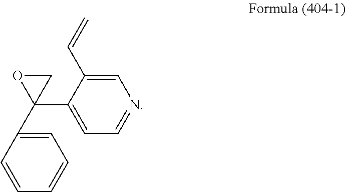 [SMILES: C=Cc1cnccc1C1(c2ccccc2)CO1]

The first amine salt was dodecyldimethylamine hydrochloride, and the second amine salt was trimethylamine hydrochloride.

Preparation of 500 g of a water phase: 5 g of guar gum, 10 g of activated calcium phosphate, 7.5 g of sodium chloride and the balance of water were weighed.

500 g of the water phase was added to a 2 L three-necked flask, and the stirring speed was controlled at 300 rpm. Oxygen was removed by introduction of nitrogen. 60 g of a compound having the structure of Formula (404-1), 30 g of divinylbenzene, 30 g of 200 # gasoline, 0.5 g of benzoyl peroxide and 1.0 g of azodiisobutyronitrile were added to a three-necked flask after removing oxygen with introduction of nitrogen for 10 min. Under the condition of keeping the introduction of nitrogen, after stirring at room temperature for 10 min, the three-necked flask was heated to a polymerization temperature of 50° C. for reaction for 2 h, then heated to 80° C. for reaction for 2 h, and cooled to room temperature, and washing, extraction and air drying were carried out to obtain the first resin.

The first resin (with an average particle size of 20 μm) was soiled. 20 g of the first resin and 60 g of dodecyldimethylamine hydrochloride were added to a 250 mL three-necked flask, the temperature was controlled at 75° C., and the mixture was stirred at 300 rpm. The solvent was ethanol. After 35 h of recondensation reaction, cooling to room temperature, filtering, and rinsing respectively twice with absolute ethanol and deionized water, the first quaternized resin was obtained with the product number of D1-1 and a total weight of 21.35 g. The first quaternized resin was added to a cleaned 250 mL three-necked flask, 50 g of a second amine salt trimethylamine hydrochloride was added, the solvent was methanol, the temperature was controlled at 70° C., and the mixture was stirred at 300 rpm. After 24 h of recondensation reaction, cooling and filtering, Soxhlet extraction (with methanol, ethanol or acetone), and sufficient rinsing with deionized water, the composite functional resin of the present invention was obtained. As measured, the strong base exchange capacity was 2.08 mmol/g, the surface charge density of the composite functional resin was about 2.42*10²³ N⁺/g, and the surface N content of the composite functional resin accounted for 19.3% of the total N content of the composite functional resin. The product number of the composite functional resin was D1, totaling 22.18 g.

### Example 14

The first monomer of this example had the structure of Formula (404), and when R₆, R₈, R₉, R₁₀, R₁₁, R₁₂ and R₁₃ were H, and R₇ was —CH₃, the first monomer had the structural formula of Formula (404-2):

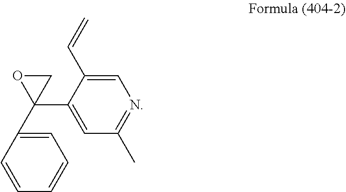 [SMILES: C=Cc1cnc(C)cc1C1(c2ccccc2)CO1]

The first amine salt was N,N-dimethylhexylamine hydrochloride, and the second amine salt was triethylamine hydrochloride.

Preparation of 500 g of a water phase: 2.5 g of hydroxyethyl cellulose, 1.5 g of methyl cellulose, 15 g of sodium sulfate and the balance of water were weighed.

500 g of the water phase was added to a 2 L three-necked flask, and the stirring speed was controlled at 220 rpm. Oxygen was removed by introduction of nitrogen. 71.1 g of the compound having the structure of Formula (404-2), 67.5 g of divinylbenzene, 82.8 g of toluene, and 24.6 g of benzoyl peroxide were added to a three-necked flask after removing oxygen with introduction of nitrogen for 10 min. Under the condition of keeping the introduction of nitrogen, after stirring at room temperature for 10 min, the three-necked flask was heated to a polymerization temperature of 85° C. for reaction for 6 h, then heated to 115° C. for reaction for 7 h, and cooled to room temperature, and washing, extraction and air drying were carried out to obtain the first resin.

The first resin (with an average particle size of 400 μm) was sorted. 20 g of the first resin and 10 g of N,N-dimethylhexylamine hydrochloride were added to a 250 mL three-necked flask, the temperature was controlled at 50° C., and the mixture was stirred at 200 rpm. The solvent was toluene. After 12 h of recondensation reaction, cooling to room temperature, filtering, and rinsing respectively twice with absolute ethanol and deionized water, the first quaternized resin was obtained with the product number of D2-1 and a total weight of 21.75 g. The above first quaternized resin was added to a cleaned 250 mL three-necked flask, 10.9 g of triethylamine hydrochloride was added, the solvent was tetrachloromethane, the temperature was controlled at 150° C., and the mixture was stirred at 800 rpm. After 72 h of recondensation reaction, cooling and filtering, Soxhlet extraction (with methanol, ethanol or acetone), and sufficient rinsing with deionized water, the composite functional resin of the present invention was obtained. As measured, the strong base exchange capacity was 2.39 mmol/g, the surface charge density of the composite functional resin was about 3.00*10²³ N⁺/g, and the surface N content of the composite functional resin accounted for 20.8% of the total N content of the composite functional resin. The product number of the composite functional resin was D2, totaling 22.43 g.

As shown in FIG. 5, the surface nitrogen contents and total nitrogen contents of the first quaternized resin D2-1 and the composite functional resin D2 were respectively measured. It can be seen that, in this example, the first quaternization reaction mainly occurred on the surface of the resin, and the second quaternization reaction mainly occurred inside the resin.

In this example, hydroxyethyl cellulose and methyl cellulose may also be replaced with one or more of gelatin, polyvinyl alcohol, activated calcium phosphate, guar gum, sodium dodecylbenzene sulfonate and sodium lignosulfonate to implement the corresponding reactions.

In this example, sodium sulfate may be replaced with one or more of trisodium phosphate, disodium hydrogen phosphate, sodium dihydrogen phosphate and sodium chloride to implement the corresponding reactions.

In this example, divinylbenzene may be replaced with one or more of ethylene glycol diethyl diallyl ester, ethylene glycol dimethacrylate, triallyl cyanurate and trimethylolpropane trimethacrylate to implement the corresponding reactions.

In this example, cyclohexanol may be replaced with one or more of isopropanol, n-butanol, 200 # solvent oil, toluene, xylene, ethyl acetate, n-octane and isooctane to implement the corresponding reactions.

### Example 15

When R₆, R₈, R₉, R₁₀, R₁₁, R₁₂ and R₁₃ were H, and R₇ was —CH₃, the structural formula of the first monomer was Formula (404-2):

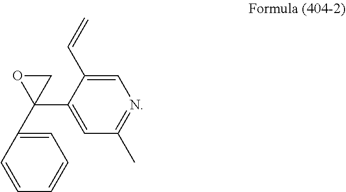 [SMILES: C=Cc1cnc(C)cc1C1(c2ccccc2)CO1]

The first monomer of this example had the structure of Formula (404-2).

The first amine salt had the structure of Formula (208-1), and the second amine salt was tripropylamine hydrochloride.

Preparation of 500 g of a water phase: 2.5 g of sodium lignosulfonate, 5 g of sodium dodecylbenzene sulfonate, 25 g of sodium sulfate, 25 g of sodium chloride and the balance of water were weighed.

500 g of the water phase was added to a 2 L three-necked flask, and the stirring speed was controlled at 380 rpm. Oxygen was removed by introduction of nitrogen. 71.1 g of the compound having the structure of Formula (404-2), 117 g of divinylbenzene, 138 g of toluene and 5.1 g of benzoyl peroxide were added to a three-necked flask after removing oxygen with introduction of nitrogen for 10 min. Under the condition of keeping the introduction of nitrogen, after stirring at room temperature for 10 min, the three-necked flask was heated to a polymerization temperature of 120° C. for reaction for 10 h, then heated to 150° C. for reaction for 12 h, and cooled to room temperature, and washing, extraction and air drying were carried out to obtain the first resin.

The pyridine first resin (with an average particle size of 10 μm) was sorted. 20 g of the first resin and 100 g of a compound having the structure of Formula (208-1) were added to a 250 mL three-necked flask, the temperature was controlled at 150° C., and the mixture was stirred at 800 rpm. The solvent was N,N-dimethylformamide. After 72 h of recondensation reaction, cooling to room temperature, filtering, and rinsing respectively twice with absolute ethanol and deionized water, the first quaternized resin was obtained with the product number of D3-1 and a total weight of 21.03 g. The above first quaternized resin was added to a cleaned 250 mL three-necked flask, 105 g of tripropylamine hydrochloride was added, the solvent was methanol, the temperature was controlled at 50° C., and the mixture was stirred at 200 rpm. After 12 h of recondensation reaction, cooling and filtering, Soxhlet extraction (with methanol, ethanol or acetone), and sufficient rinsing with deionized water, the composite functional resin of the present invention was obtained. As measured, the strong base exchange capacity was 1.82 mmol/g, the surface charge density of the composite functional resin was about 1.91*10²³ N⁺/g, and the surface N content of the composite functional resin accounted for 17.4% of the total N content of the composite functional resin. The product number of the composite functional resin was D3, totaling 21.90 g.

The number of repeating units of the composite functional resin in this example was in a range of 500-800.

### Example 16

When R₆, R₈, R₉, R₁₀, R₁₁, R₁₂ and R₁₃ were H, and R₇ was —CH₃, the structural formula of the first monomer was Formula (404-2):

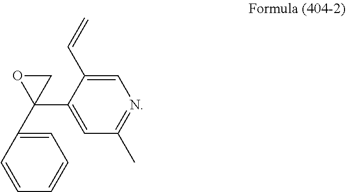 [SMILES: C=Cc1cnc(C)cc1C1(c2ccccc2)CO1]

The first monomer of this example had the structure of Formula (404-2).

The first amine salt was dioctadecylmethylamine hydrochloride.

The second amine salt had the structure of Formula (202-2).

Preparation of 500 g of a water phase: 5 g of gelatin, 1 g of activated calcium phosphate, 7.5 g of sodium chloride, and the balance of water were weighed.

500 g of the water phase was added to a 2 L three-necked flask, and the stirring speed was controlled at 200 rpm. Oxygen was removed by introduction of nitrogen. 71.1 g of the compound having the structure of Formula (404-2), 19.5 g of divinylbenzene, 27.6 g of toluene and 0.6 g of benzoyl peroxide were added to a three-necked flask after removing oxygen with introduction of nitrogen for 10 min. Under the condition of keeping the introduction of nitrogen, after stirring at room temperature for 10 min, the three-necked flask was heated to a polymerization temperature of 90° C. for reaction for 10 h, then heated to 120° C. for reaction for 4 h, and cooled to room temperature, and washing, extraction and air drying were carried out to obtain the first resin.

The first resin (with an average particle size of 300 μm) was sorted. 20 g of the first resin and 200 g of dioctadecylmethylamine hydrochloride were added in a 250 mL three-necked flask, the temperature was controlled at 100° C., and the mixture was stirred at 501 rpm. The solvent was toluene. After 40 h of recondensation reaction, cooling to room temperature, filtering, and rinsing respectively twice with absolute ethanol and deionized water, the first quaternized resin was obtained with the product number of D4-1 and a total weight of 21.28 g. The first quaternized resin was added to a cleaned 250 mL three-necked flask, 210.3 g of a compound having the structure of Formula (202-2) was added, the solvent was ethanol, the temperature was controlled at 100° C., and the mixture was stirred at 497 rpm. After 40 h of recondensation reaction, cooling and filtering, Soxhlet extraction (with one or any combination of methanol, ethanol and acetone), and sufficient rinsing with deionized water, the composite functional resin of the present invention was obtained. As measured, the strong base exchange capacity was 1.95 mmol/g, the surface charge density of the composite functional resin was about 1.87*10²³ N⁺/g, and the surface N content of the composite functional resin accounted for 15.9% of the total N content of the composite functional resin. The product number of the composite functional resin was D4, totaling 22.35 g.

### Example 17

This example was the evaluation of the bactericidal performance of quaternary ammonium salt resin.

E. coli ATCC8099 was used. After being cultured in nutrient broth, the E. coli was diluted to 10⁵ CFU/mL by Cl⁻ with the concentrations of 0 mg/L, 100 mg/L and 1,000 mg/L. 100 mL of the prepared experimental bacterial liquid was added to a 250 mL Erlenmeyer flask, 0.5 g of the resin A0 obtained in Example 1 and 0.5 g of the resin A1 obtained in Example 2 were added, and then the Erlenmeyer flask was placed in a shaker at 200 rpm and 20±1° C. for 60 min. Finally, 100 μl of the bacterial liquid was separately taken to carry out spread plate counting, and the bactericidal efficiency of the quaternary ammonium salts was calculated. The evaluation results were shown in the following table 1:

TABLE 1
Removal effects of different quaternary ammonium salt resins on E. coli

| | Amount of | | | | | |
|---|---|---|---|---|---|---|
| | bactericide | Cl⁻ content | Sterilizing | Initial colony | Viable colony | Sterilizing |
| | mg/ml bacterial | in the | time | forming units | forming units | rate |
| Resin type | liquid | system mg/L | min | CFU/mL | CFU/mL | (%) |
| A0 | 5 | 0 | 60 | 7.3 × 10⁵ | 8.9 × 10² | 99.88% |
| A0 | 5 | 100 | 60 | 7.5 × 10⁵ | 5.6 × 10⁴ | 92.53% |
| A0 | 5 | 1,000 | 60 | 7.9 × 10⁵ | 4.4 × 10⁵ | 44.30% |
| A1 | 5 | 0 | 60 | 6.9 × 10⁵ | 4.2 × 10² | 99.94% |
| A1 | 5 | 100 | 60 | 7.2 × 10⁵ | 1.1 × 10³ | 99.85% |
| A1 | 5 | 1,000 | 60 | 6.7 × 10⁵ | 2.9 × 10³ | 99.57% |

Note:
A0-control group (quaternization with only dodecyl dimethyl tertiary amine); A1-experimental group (quaternization with dodecyldimethylamine hydrochloride + triethylamine hydrochloride).

### Example 18

This example was the evaluation of the bactericidal performance of quaternary ammonium salt resin.

P. aeruginosa ATCC15442 was used. After being cultured in nutrient broth, the P. aeruginosa was diluted to 10⁶ CFU/mL by Cl⁻ with the concentrations of 0 mg/L, 100 mg/L and 1,000 mg/L. 100 mL of the prepared experimental bacterial liquid was added to a 250 mL Erlenmeyer flask, 0.5 g of the resin A0 obtained in Example 1 and 0.5 g of the resin A1 obtained in Example 2 were added, and then the Erlenmeyer flask was placed in a shaker at 200 rpm and 20±1° C. for 60 min. Finally, 100 μl of the bacterial liquid was separately taken to carry out spread plate counting, and the bactericidal efficiency of the quaternary ammonium salts was calculated. The evaluation results were shown in the following table 2:

TABLE 2
Removal effects of different quaternary ammonium salt resins on P. aeruginosa

| | Amount of | | | | | |
|---|---|---|---|---|---|---|
| | bactericide | Cl⁻ content | Sterilizing | Initial colony | Viable colony | Sterilizing |
| | mg/ml bacterial | in the | time | forming units | forming units | rate |
| Resin type | liquid | system mg/L | min | CFU/mL | CFU/mL | (%) |
| A0 | 5 | 0 | 60 | 1.9 × 10⁶ | 1.3 × 10² | 99.99% |
| A0 | 5 | 100 | 60 | 1.5 × 10⁶ | 5.7 × 10⁴ | 96.20% |
| A0 | 5 | 1,000 | 60 | 1.7 × 10⁶ | 8.1 × 10⁵ | 52.35% |
| A1 | 5 | 0 | 60 | 2.4 × 10⁶ | 2.2 × 10² | 99.99% |
| A1 | 5 | 100 | 60 | 2.1 × 10⁶ | 9.8 × 10² | 99.95% |
| A1 | 5 | 1,000 | 60 | 1.9 × 10⁶ | 3.7 × 10³ | 99.81% |

Note:
A0-control group (quaternization with only dodecyl dimethyl tertiary amine); A1-experimental group (quaternization with dodecyldimethylamine hydrochloride + triethylamine hydrochloride).

### Example 19

This example was the evaluation of the bactericidal performance of quaternary ammonium salt resin.

E. coli ATCC8099 was used. After being cultured in nutrient broth, the E. coli was diluted to 105 CFU/mL by NOM with the concentrations of 0 mg/L, 1 mg/L, 3 mg/L and 5 mg/L. 100 mL of the prepared experimental bacterial liquid was added to a 250 mL Erlenmeyer flask, 0.5 g of the resin A0 obtained in Example 1 and 0.5 g of the resin A1 obtained in Example 2 were added, and then the Erlemneyer flask was placed in a shaker at 200 rpm and 20±1° C. for 60 min. Finally, 100 μl of the bacterial liquid was separately taken to carry out spread plate counting, and the bactericidal efficiency of the quaternary ammonium salts was calculated. The evaluation results were shown in the following table 3:

TABLE 3
Removal effects of different quaternary ammonium salt resins on E. coli

| | Amount of | | | | | |
|---|---|---|---|---|---|---|
| | bactericide | NOM | Sterilizing | Initial colony | Viable colony | Sterilizing |
| | mg/ml bacterial | concentration | time | forming units | forming units | rate |
| Resin type | liquid | mg/L | min | CFU/mL | CFU/mL | (%) |
| A0 | 5 | 0 | 60 | 7.3 × 10⁵ | 8.5 × 10² | 99.88% |
| A0 | 5 | 1 | 60 | 7.5 × 10⁵ | 6.6 × 10³ | 99.12% |
| A0 | 5 | 3 | 60 | 7.9 × 10⁵ | 3.9 × 10⁵ | 50.63% |
| A0 | 5 | 5 | 60 | 7.5 × 10⁵ | 5.3 × 10⁵ | 29.33% |
| A1 | 5 | 0 | 60 | 6.1 × 10⁵ | 3.1 × 10² | 99.95% |
| A1 | 5 | 1 | 60 | 6.8 × 10⁵ | 1.1 × 10³ | 99.83% |
| A1 | 5 | 3 | 60 | 5.7 × 10⁵ | 5.0 × 10³ | 99.12% |
| A1 | 5 | 5 | 60 | 6.3 × 10⁵ | 1.6 × 10⁵ | 74.60% |

Note:
A0-control group (quaternization with only dodecyl dimethyl tertiary amine); A1-experimental group (quaternization with dodecyldimethylamine hydrochloride + triethylamine hydrochloride).

### Example 20

This example was the evaluation of the bactericidal performance of quaternary ammonium salt resin.

P. aeruginosa ATCC15442 was used. After being cultured in nutrient broth, the P. aeruginosa was diluted to 10⁶ CFU/mL by NOM with the concentrations of 0 mg/L, 1 mg/L, 3 mg/L and 5 mg/L. 100 mL of the prepared experimental bacterial liquid was added to a 250 mL Erlenmeyer flask, 0.5 g of the resin A0 obtained in Example 1 and 0.5 g of the resin A1 obtained in Example 2 were added, and then the Erlenmeyer flask was placed in a shaker at 200 rpm and 20±1° C. for 60 min. Finally, 100 μl of the bacterial liquid was separately taken to carry out spread plate counting, and the bactericidal efficiency of the quaternary ammonium salts was calculated. The evaluation results were shown in the following table 4:

TABLE 4
Removal effects of different quaternary ammonium salt resins on P. aeruginosa

| | Amount of | | | | | |
|---|---|---|---|---|---|---|
| | bactericide | NOM | Sterilizing | Initial colony | Viable colony | Sterilizing |
| | mg/ml bacterial | concentration | time | forming units | forming units | rate |
| Resin type | liquid | mg/L | Min | CFU/mL | CFU/mL | (%) |
| A0 | 5 | 0 | 60 | 1.9 × 10⁶ | 1.3 × 10³ | 99.93% |
| A0 | 5 | 1 | 60 | 1.5 × 10⁶ | 2.7 × 10³ | 99.82% |
| A0 | 5 | 3 | 60 | 1.7 × 10⁶ | 6.2 × 10⁵ | 63.53% |
| A0 | 5 | 5 | 60 | 1.7 × 10⁶ | 1.1 × 10⁶ | 35.29% |
| A1 | 5 | 0 | 60 | 6.9 × 10⁵ | 4.2 × 10² | 99.99% |
| A1 | 5 | 1 | 60 | 7.2 × 10⁵ | 4.1 × 10² | 99.94% |
| A1 | 5 | 3 | 60 | 6.7 × 10⁵ | 8.0 × 10² | 99.88% |
| A1 | 5 | 5 | 60 | 6.7 × 10⁵ | 1.3 × 10⁴ | 80.60% |

Note:
A0-control group (quaternization with only dodecyl dimethyl tertiary amine); A1-experimental group (quaternization with dodecyldimethylamine hydrochloride + triethylamine hydrochloride).

### Example 21

This example was the evaluation of the bactericidal performance and pollutant removal performance of quaternary ammonium salt resin.

The experimental bacterial liquid was replaced with the actual water body, and the water quality parameters were as follows: TOC was 2.10 mg/L, NO₃⁻ 0.41 mg/L, Cl⁻ 68 mg/L, and SO₄²⁻ 55 mg/L. 10 L of the actual water body was taken, 50 g of the resin A0 obtained in Example 1 and 50 g of the resin A1 obtained in Example 2 were added, and then stirred at 200 rpm and 20±1° C. for 60 min. Finally, 100 μl of the bacterial liquid was separately taken to carry out spread plate counting, and the bactericidal efficiency of the quaternary ammonium salts was calculated. The evaluation results were shown in the following tables 5 and 6:

TABLE 5
Removal effects of different quaternary ammonium salt resins
on total number of bacteria in actual water bodies

| | Amount of | | | | |
|---|---|---|---|---|---|
| | bactericide | Sterilizing | Initial colony | Viable colony | Sterilizing |
| | mg/ml bacterial | time | forming units | forming units | rate |
| Resin type | liquid | min | CFU/mL | CFU/mL | (%) |
| A0 | 5 | 60 | 3.8 × 10⁴ | 1.1 × 10⁴ | 71.05% |
| A1 | 5 | 60 | 3.8 × 10⁴ | 12 | 99.97% |

TABLE 6
Removal effects of different quaternary ammonium
salt resins on TOC in actual water bodies

| | Amount of | Adsorption | | | Removal |
|---|---|---|---|---|---|
| | resin mg/ml | time | | | rate |
| Resin type | bacterial liquid | min | TOC mg/L | TOC mg/L | (%) |
| A0 | 5 | 60 | 2.10 | 1.67 | 20.47% |
| A1 | 5 | 60 | 2.10 | 1.08 | 48.57% |

### Example 22

This example was the evaluation of the removal effects of quaternary ammonium salt resins on pathogenic bacteria and pollutants in actual drinking water.

Sand filtered water from a water plant was used, and the water quality parameters were as follows: TOC was 3.30 mg/L, NO₃⁻ 1.52 mg/L, Cl⁻ 48 mg/L, and SO₄²⁻ 27 mg/L. 10 L of the actual water body was taken, 50 g of the resin A0 obtained in Example 1 and 50 g of the resin A1 obtained in Example 2 were added, and then stirred at 200 rpm and 20±1° C. for 60 min. Finally, 100 μl of the bacterial liquid was separately taken to carry out spread plate counting, and the bactericidal efficiency of the quaternary ammonium salts was calculated. The evaluation results were shown in the following tables 7-10:

TABLE 7
Removal effects of different quaternary ammonium salt resins
on total number of bacteria in actual water bodies

| | Amount of | | | | |
|---|---|---|---|---|---|
| | bactericide | Sterilizing | Initial colony | Viable colony | Sterilizing |
| | mg/ml bacterial | time | forming units | forming units | rate |
| Resin type | liquid | min | CFU/mL | CFU/mL | (%) |
| A0 | 5 | 60 | 5.4 × 10⁴ | 9.5 × 10³ | 82.40% |
| A1 | 5 | 60 | 5.4 × 10⁴ | 4.5 × 10² | 99.17% |

TABLE 8
Removal effects of different quaternary ammonium
salt resins on E. coli in actual water bodies

| | Amount of | | | | |
|---|---|---|---|---|---|
| | bactericide | Sterilizing | Initial colony | Viable colony | Sterilizing |
| | mg/ml bacterial | time | forming units | forming units | rate |
| Resin type | liquid | min | CFU/mL | CFU/mL | (%) |
| A0 | 5 | 60 | 2.1 × 10² | 81 | 61.42% |
| A1 | 5 | 60 | 2.1 × 10² | 3 | 98.57% |

TABLE 9
Removal effects of different quaternary ammonium salt
resins on P. aeruginosa in actual water bodies

| | Amount of | | | | |
|---|---|---|---|---|---|
| | bactericide | Sterilizing | Initial colony | Viable colony | Sterilizing |
| | mg/ml bacterial | time | forming units | forming units | rate |
| Resin type | liquid | min | CFU/mL | CFU/mL | (%) |
| A0 | 5 | 60 | 1.3 × 10² | 30 | 76.92% |
| A1 | 5 | 60 | 1.3 × 10² | 8 | 93.85% |

TABLE 10
Removal effects of different quaternary ammonium
salt resins on TOC in actual water bodies

| | Amount of | | | | |
|---|---|---|---|---|---|
| | bactericide | Adsorption | | | Removal |
| | mg/ml bacterial | time | TOC before | TOC after | rate |
| Resin type | liquid | min | treatment mg/L | treatment mg/L | (%) |
| A0 | 5 | 60 | 3.3 | 2.15 | 34.85% |
| A1 | 5 | 60 | 3.3 | 1.72 | 47.88% |

### Example 23

This example was the evaluation of the bactericidal performance of quaternary ammonium salt resin.

P. aeruginosa ATCC15442 was used. After being cultured in nutrient broth, the P. aeruginosa was diluted to 106 CFU/mL by Cl⁻ with the concentrations of 0 mg/L, 100 mg/L and 1,000 mg/L. 100 mL of the prepared experimental bacterial liquid was added to a 250 mL Erlenmeyer flask, 0.5 g of the resin B3 synthesized in Example 7 was added, and then the Erlenmeyer flask was placed in a shaker at 200 rpm and 20±1° C. for 60 min. Finally, 100 μl of the bacterial liquid was separately taken to carry out spread plate counting, and the bactericidal efficiency of the quaternary ammonium salts was calculated. The evaluation results were shown in the following table 11:

TABLE 11
Removal effects of different quaternary ammonium salt resins on P. aeruginosa

| | Amount of | | | | | |
|---|---|---|---|---|---|---|
| | bactericide | Cl⁻ content | Sterilizing | Initial colony | Viable colony | Sterilizing |
| | mg/ml bacterial | in the | time | forming units | forming units | rate |
| Resin type | liquid | system mg/L | min | CFU/mL | CFU/mL | (%) |
| B3 | 5 | 0 | 60 | 1.9 × 10⁶ | 2.4 × 10⁵ | 87.37% |
| B3 | 5 | 100 | 60 | 1.7 × 10⁶ | 3.0 × 10⁵ | 82.35% |
| B3 | 5 | 1,000 | 60 | 2.0 × 10⁶ | 5.3 × 10⁵ | 73.50% |

### Example 24

This example was the evaluation of the bactericidal performance of quaternary ammonium salt resin.

P. aeruginosa ATCC15442 was used. After being cultured in nutrient broth, the P. aeruginosa was diluted to 106 CFU/mL by Cl⁻ with the concentrations of 0 mg/L, 100 mg/L and 1,000 mg/L. 100 mL of the prepared experimental bacterial liquid was added to a 250 mL Erlenmeyer flask, 0.5 g of the resin C2 synthesized in Example 10 was added, and then the Erlenmeyer flask was placed in a shaker at 200 rpm and 20±1° C. for 60 min. Finally, 100 μl of the bacterial liquid was separately taken to carry out spread plate counting, and the bactericidal efficiency of the quaternary ammonium salts was calculated. The evaluation results were shown in the following table 12:

TABLE 12
Removal effects of different quaternary ammonium salt resins on P. aeruginosa

| | Amount of | | | | | |
|---|---|---|---|---|---|---|
| | bactericide | Cl⁻ content | Sterilizing | Initial colony | Viable colony | Sterilizing |
| | mg/ml bacterial | in the | time | forming units | forming units | rate |
| Resin type | liquid | system mg/L | min | CFU/mL | CFU/mL | (%) |
| C2 | 5 | 0 | 60 | 2.9 × 10⁶ | 7.1 × 10⁵ | 75.99% |
| C2 | 5 | 100 | 60 | 2.7 × 10⁶ | 8.6 × 10⁵ | 67.95% |
| C3 | 5 | 1,000 | 60 | 2.6 × 10⁶ | 1.5 × 10⁶ | 42.81% |

### Example 25

This example was the evaluation of the bactericidal performance of quaternary ammonium salt resin.

P. aeruginosa ATCC15442 was used. After being cultured in nutrient broth, the P. aeruginosa was diluted to 10⁶ CFU/mL by Cl⁻ with the concentrations of 0 mg/L, 100 mg/L and 1,000 mg/L. 100 mL of the prepared experimental bacterial liquid was added to a 250 mL Erlenmeyer flask, 0.5 g of the resin C4 synthesized in Example 12 was added, and then the Erlenmeyer flask was placed in a shaker at 200 rpm and 20±1° C. for 60 min. Finally, 100 μl of the bacterial liquid was separately taken to carry out spread plate counting, and the bactericidal efficiency of the quaternary ammonium salts was calculated. The evaluation results were shown in the following table 13:

TABLE 13
Removal effects of different quaternary ammonium salt resins on P. aeruginosa

| | Amount of | | | | | |
|---|---|---|---|---|---|---|
| | bactericide | Cl⁻ content | Sterilizing | Initial colony | Viable colony | Sterilizing |
| | mg/ml bacterial | in the | time | forming units | forming units | rate |
| Resin type | liquid | system mg/L | min | CFU/mL | CFU/mL | (%) |
| C4 | 5 | 0 | 60 | 2.8 × 10⁶ | 5.5 × 10⁵ | 80.36% |
| C4 | 5 | 100 | 60 | 2.7 × 10⁶ | 1.1 × 10⁵ | 59.26% |
| C4 | 5 | 1,000 | 60 | 3.0 × 10⁶ | 1.9 × 10³ | 36.67% |

### Example 26

This example was the evaluation of the bactericidal performance of quaternary ammonium salt resin.

P. aeruginosa ATCC15442 was used. After being cultured in nutrient broth, the P. aeruginosa was diluted to 106 CFU/mL by Cl⁻ with the concentrations of 0 mg/L, 100 mg/L and 1,000 mg/L. 100 mL of the prepared experimental bacterial liquid was added to a 250 mL Erlemneyer flask, 0.5 g of the resin D3 synthesized in Example 15 was added, and then the Erlenmeyer flask was placed in a shaker at 200 rpm and 20±1° C. for 60 min. Finally, 100 μl of the bacterial liquid was separately taken to carry out spread plate counting, and the bactericidal efficiency of the quaternary ammonium salts was calculated. The evaluation results were shown in the following table 14:

TABLE 14
Removal effects of different quaternary ammonium salt resins on P. aeruginosa

| | Amount of | | | | | |
|---|---|---|---|---|---|---|
| | bactericide | Cl⁻ content | Sterilizing | Initial colony | Viable colony | Sterilizing |
| | mg/ml bacterial | in the | time | forming units | forming units | rate |
| Resin type | liquid | system mg/L | min | CFU/mL | CFU/mL | (%) |
| D3 | 5 | 0 | 60 | 1.5 × 10⁶ | 1.6 × 10⁵ | 89.33% |
| D3 | 5 | 100 | 60 | 1.5 × 10⁶ | 4.3 × 10⁵ | 71.33% |
| D3 | 5 | 1,000 | 60 | 1.4 × 10⁶ | 9.2 × 10⁵ | 34.29% |

### Example 27

This example was the evaluation of the bactericidal performance of quaternary ammonium salt resin.

This example also was the evaluation of the removal effects of quaternary ammonium salt resins on pathogenic bacteria and pollutants in actual drinking water.

Sand filtered water from a water plant was used, and the water quality parameters were as follows: TOC was 2.85 mg/L, NO₃⁻ 1.38 mg/L, Cl⁻ 65 mg/L, and SO₄²⁻ 34 mg/L. 10 L of the actual water body was taken, then 50 g of each of resin A2, B3, C2 and D2 synthesized in Example 3, Example 7, Example 10 and Example 14 were respectively added, and stirred at 200 rpm and 20±1° C. for 60 min. Finally, 100 μl of the bacterial liquid was separately taken to carry out spread plate counting, and the bactericidal efficiency of the quaternary ammonium salts was calculated. The evaluation results were shown in the following tables 15-18:

TABLE 15
Removal effects of different quaternary ammonium salt resins
on total number of bacteria in actual water bodies

| | Amount of | | | | |
|---|---|---|---|---|---|
| | bactericide | Sterilizing | Initial colony | Viable colony | Sterilizing |
| | mg/ml bacterial | time | forming units | forming units | rate |
| Resin type | liquid | min | CFU/mL | CFU/mL | (%) |
| A2 | 5 | 60 | 7.8 × 10⁴ | 2.2 × 10 | 99.97% |
| B3 | 5 | 60 | 7.8 × 10⁴ | 1.1 × 10⁴ | 85.90% |
| C2 | 5 | 60 | 7.8 × 10⁴ | 8.9 × 10³ | 88.59% |
| D2 | 5 | 60 | 7.8 × 10⁴ | 6.2 × 10² | 99.20% |

TABLE 16
Removal effects of different quaternary ammonium
salt resins on E. coli in actual water bodies

| | Amount of | | | | |
|---|---|---|---|---|---|
| | bactericide | Sterilizing | Initial colony | Viable colony | Sterilizing |
| | mg/ml bacterial | time | forming units | forming units | rate |
| Resin type | liquid | min | CFU/mL | CFU/mL | (%) |
| A2 | 5 | 60 | 8.6 × 10² | 12 | 98.60% |
| B3 | 5 | 60 | 8.6 × 10² | 98 | 88.60% |
| C2 | 5 | 60 | 8.6 × 10² | 84 | 90.23% |
| D2 | 5 | 60 | 8.6 × 10² | 27 | 96.86% |

TABLE 17
Removal effects of different quaternary ammonium salt
resins on P. aeruginosa in actual water bodies

| | Amount of | | | | |
|---|---|---|---|---|---|
| | bactericide | Sterilizing | Initial colony | Viable colony | Sterilizing |
| | mg/ml bacterial | time | forming units | forming units | rate |
| Resin type | liquid | min | CFU/mL | CFU/mL | (%) |
| A2 | 5 | 60 | 5.3 × 10² | 26 | 95.09% |
| B3 | 5 | 60 | 5.3 × 10² | 87 | 83.58% |
| C2 | 5 | 60 | 5.3 × 10² | 79 | 85.09% |
| D2 | 5 | 60 | 5.3 × 10² | 41 | 92.26% |

TABLE 18
Removal effects of different quaternary ammonium
salt resins on TOC in actual water bodies

| | Amount of | Adsorption | | | Removal |
|---|---|---|---|---|---|
| | resin mg/ml | time | TOC before | TOC after | rate |
| Resin type | bacterial liquid | min | treatment mg/L | treatment mg/L | (%) |
| A2 | 5 | 60 | 2.85 | 1.43 | 49.82% |
| B3 | 5 | 60 | 2.85 | 1.73 | 39.30% |
| C2 | 5 | 60 | 2.85 | 1.69 | 42.10% |
| D2 | 5 | 60 | 2.85 | 1.57 | 44.91% |

1. A composite functional resin, wherein the composite functional resin has the basic structure of Formula (I) and/or Formula (II), 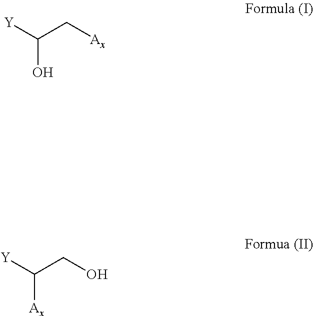
wherein A_{X} is a quaternary ammonium group; and
Y has the structure of any one or more of Formula (101), Formula (102), Formula (103) and Formula (104), 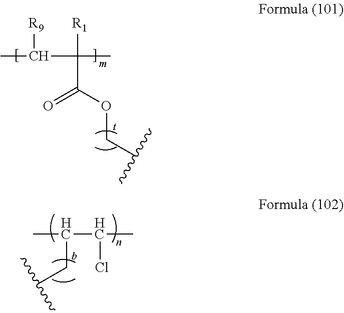
wherein R₀, R₁, R₂, R₃, R₄, R₅, R₆, R₇, R₈, R₉, R₁₀, R₁₁, R₁₂ and R₁₃ are H or hydrocarbyl groups; m, n, k and p are the number of repeating units, ranging from 500 to 3,000; the number of carbon atoms of t and q is in a range of 1-30; and the number of carbon atoms of R₀, R₁, R₂, R₃, R₄, R₅, R₆, R₇, R₈, R₉, R₁₀, R₁₁, R₁₂ and R₁₃ is in a range of 0-30.

2. The composite functional resin of claim 1, wherein the composite functional resin has the crosslinking degree of 1-35%, the particle size of 10-2,000 m, and the surface N content of 0.005-50.0% of the total N content of the composite functional resin.

3. The composite functional resin of claim 1, wherein the composite functional resin has the crosslinking degree of 10-25%, the particle size of 20-600 m, the strong base exchange capacity of 0.3-4.0 mmol/g, and the resin surface charge density of 1015-10²⁴ N⁺/g.

4. The composite functional resin of claim 1, wherein A_{X} has the structure of any one or more of Formula (201), Formula (202), Formula (203), Formula (204), Formula (205), Formula (206), Formula (207), Formula (208), Formula (209) and Formula (210), 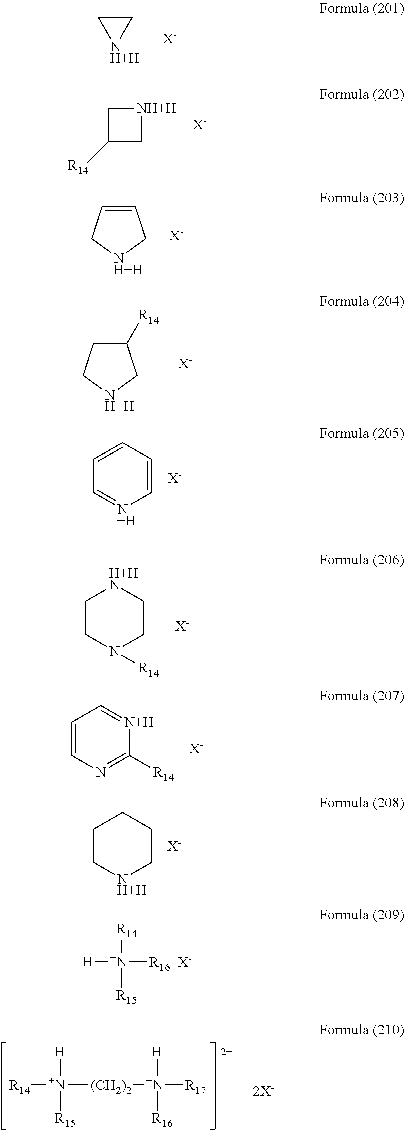
wherein X is any one of Cl⁻, Br⁻, I⁻, I3⁻, I5⁻, I7⁻, OH⁻, SO₄²⁻, HCO₃⁻, and CO₃²⁻; R₁₄, R₁₅, R₁₆ and R₁₇ are respectively one of H or a hydrocarbyl group; and
the number of carbon atoms of R₁₄, R₁₅, R₁₆ and R₁₇ is in a range of 0-40.

5. A preparation method of a composite functional resin, comprising the following steps:
(1) mixing a first resin, a first amine salt and a solvent C, and stirring the mixture for a first quaternization reaction to obtain the first quaternized resin; and
(2) mixing the first quaternized resin in step (1), a second amine salt, and a solvent D, and stirring the mixture for a second quaternization reaction to obtain the composite functional resin.

6. The preparation method of a composite functional resin of claim 5, wherein the weight ratio of the first resin to the first amine salt in step (1) is 1:(0.5-10).

7. The preparation method of a composite functional resin of claim 6, wherein the reaction conditions in step (1) are: the reaction time is 12-72 h, the stirring speed is 200-800 rpm, and the reaction temperature is 50-150° C.

8. The preparation method of a composite functional resin of claim 5, wherein the weight ratio of the first quaternized resin to the second amine salt in step (2) is 1:(0.5-10).

9. The preparation method of a composite functional resin of claim 5, wherein the reaction conditions in step (2) are: the reaction time is 12-72 h, the stirring speed is 200-800 rpm, and the reaction temperature is 50-150° C.

10. The preparation method of a composite functional resin of claim 5, wherein the first amine salt has the structure of one or more of Formula (201), Formula (202), Formula (203), Formula (204), Formula (205), Formula (206), Formula (207), Formula (208), Formula (209) and Formula (210), 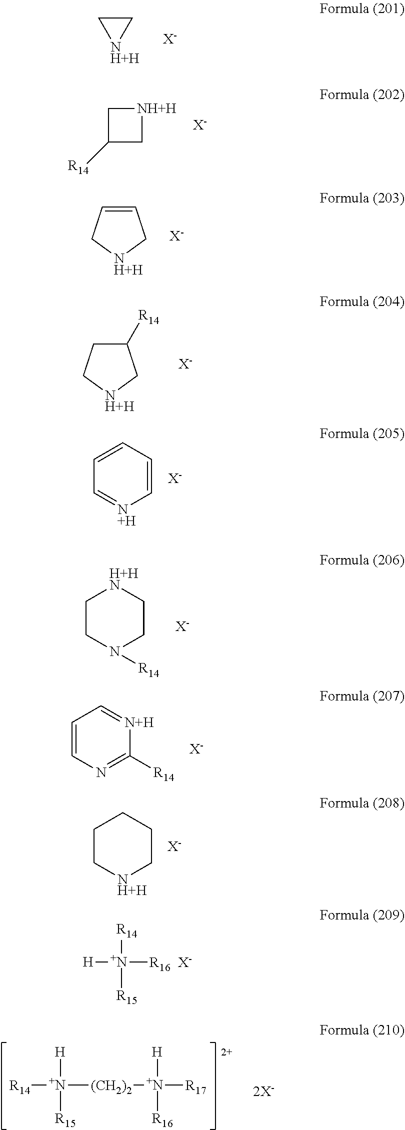
wherein X is any one of Cl⁻, Br⁻, I⁻, I3⁻, I5⁻, I7⁻, OH⁻, SO₄²⁻, HCO₃⁻, and CO₃²⁻; R₁₄, R₁₅, R₁₆ and R₁₇ are respectively one of H or a hydrocarbyl group; and the number of carbon atoms of R₁₄, R₁₅, R₁₆ and R₁₇ is in a range of 0-40.

11. The preparation method of a composite functional resin of claim 5, wherein the second amine salt has the structure of one or more of Formula (201), Formula (202), Formula (203), Formula (204), Formula (205), Formula (206), Formula (207), Formula (208), Formula (209) and Formula (210), 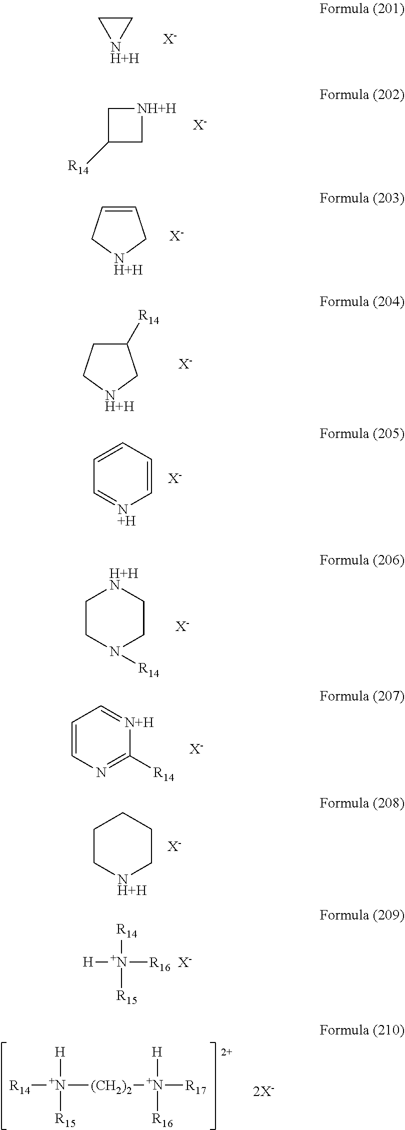
wherein X is any one of Cl⁻, Br⁻, I⁻, I3⁻, I5⁻, I7⁻, OH⁻, SO₄²⁻, HCO₃⁻, and CO₃²⁻; R₁₄, R₁₅, R₁₆ and R₁₇ are respectively one of H or a hydrocarbyl group; and the number of carbon atoms of R₁₄, R₁₅, R₁₆ and R₁₇ is in a range of 0-40.

12. The preparation method of a composite functional resin of claim 5, wherein the solvent C is one or more of water, methanol, ethanol, acetone, acetonitrile, benzene, toluene, tetrahydrofuran, dichloromethane, N,N-dimethylformamide, ethyl acetate, petroleum ether, hexane, diethyl ether and tetrachloromethane; and the solvent D is one or more of water, methanol, ethanol, acetone, acetonitrile, benzene, toluene, tetrahydrofuran, dichloromethane, N,N-dimethylformamide, ethyl acetate, petroleum ether, hexane, diethyl ether and tetrachloromethane.

13. The preparation method of a composite functional resin of claim 5, wherein the following steps are further comprised before step (1):
(a) preparing a water phase: mixing a sodium salt-containing aqueous solution and a dispersant, and stirring the mixture to obtain the water phase, wherein the dispersant accounts for 0.1-2.0% of the water phase by weight;
(b) preparing an oil phase: mixing a first monomer, a crosslinking agent, an initiator, and a porogen to obtain the oil phase, wherein the first monomer and the crosslinking agent form a reactant; and
(c) preparing a first resin: adding the oil phase in step (b) to the water phase in step (a), stirring and heating the mixture, controlling the temperature at 50-120° C. for reaction for 2-10 h, then controlling the temperature at 80-150° C. for reaction for 2-12 h, cooling the mixture to room temperature, extracting and washing to obtain the first resin.

14. The preparation method of a composite functional resin of claim 13, wherein the dispersant in step (a) is one or more of hydroxyethyl cellulose, gelatin, polyvinyl alcohol, activated calcium phosphate, guar gum, methyl cellulose, sodium dodecylbenzene sulfonate and sodium lignosulfonate; the sodium salt in step (a) is one or more of trisodium phosphate, disodium hydrogen phosphate, sodium dihydrogen phosphate and sodium chloride; the crosslinking agent in step (b) is one or more of ethylene glycol diethyl diallyl ester, ethylene glycol dimethacrylate, divinylbenzene, triallyl cyanurate and trimethylolpropane trimethacrylate; the porogen in step (b) is one or more of cyclohexanol, isopropanol, n-butanol, 200 # solvent oil, toluene, xylene, ethyl acetate, n-octane and isooctane; and the initiator in step (b) is one or more of azobisisobutyronitrile and benzoyl peroxide.

15. The preparation method of a composite functional resin of claim 13, wherein in step (b), the molar ratio of the first monomer to the crosslinking agent is 1:(0.05-0.3), the molar ratio of the first monomer to the porogen is 1:(0.1-0.5), and the weight of the initiator accounts for 0.5-1.5% of the total weight of the oil phase.

16. The composite functional resin prepared by the preparation method of claim 5, wherein the basic structure of the first resin is one or more of Formula (301), Formula (302), Formula (303) and Formula (304), 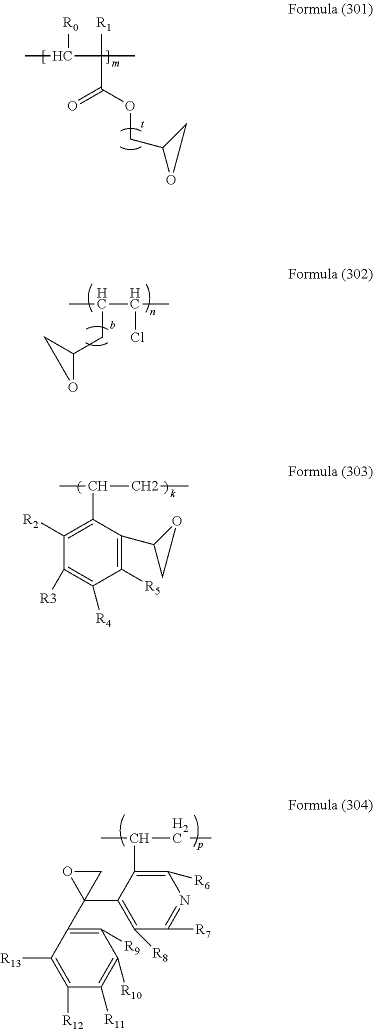
wherein R₀, R₁, R₂, R₃, R₄, R₅, R₆, R₇, R₈, R₉, R₁₀, R₁₁, R₁₂ and R₁₃ are H or hydrocarbyl groups; the number of carbon atoms of R₀, R₁, R₂, R₃, R₄, R₅, R₆, R₇, R₈, R₉, R₁₀, R₁₁, R₁₂ and R₁₃ is in a range of 0-30;
m, n, k and p are the number of repeating units, ranging from 500 to 3,000; and
the number of carbon atoms of t and q is in a range of 1-30.

17. The composite functional resin prepared by the preparation method of claim 13, wherein the first monomer has the structure of one or more of Formula (401), Formula (402), Formula (403) and Formula (404), 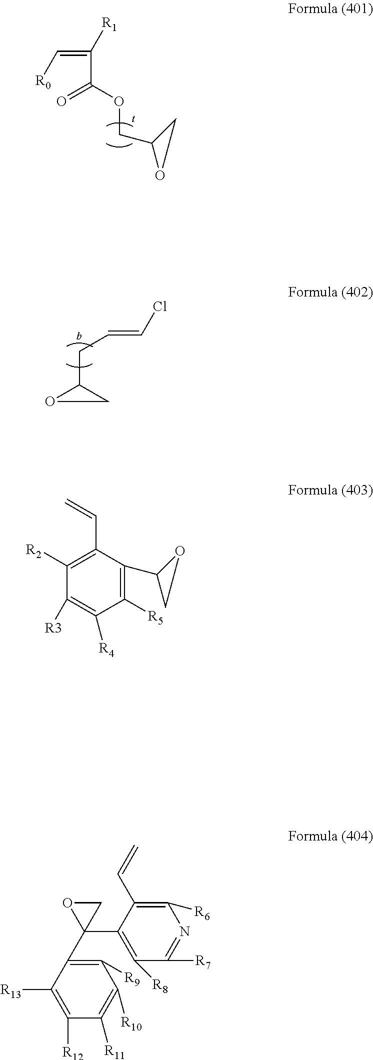
wherein R₀, R₁, R₂, R₃, R₄, R₅, R₆, R₇, R₈, R₉, R₁₀, R₁₁, R₁₂ and R₁₃ are H or hydrocarbyl groups; the number of carbon atoms of R₀, R₁, R₂, R₃, R₄, R₅, R₆, R₇, R₈, R₉, R₁₀, R₁₁, R₁₂ and R₁₃ is in a range of 0-30; and
the number of carbon atoms of t and q is in a range of 1-30.

18. Application of a composite functional resin in sterilization, wherein the composite functional resin is the composite functional resin of claim 1.

19. Application of a composite functional resin in water treatment, wherein the composite functional resin is the composite functional resin of claim 1.
